(19) United States
(12) Patent Application Publication
(10) Pub. No.: US 2013/0345058 A1
(43) Pub. Date: Dec. 26, 2013

(54) USE OF LIPOCHITO-OLIGOSACCHARIDE COMPOUNDS FOR SAFEGUARDING SEED SAFETY OF TREATED SEEDS

(71) Applicants: Wolfram Andersch, Bergisch Gladbach (DE); Ruth Meissner, Leverkusen (DE); Daniela Portz, Vettweiss (DE); Jean-Pierre Vors, Sainte-Foy-Les-Lyon (FR)

(72) Inventors: Wolfram Andersch, Bergisch Gladbach (DE); Ruth Meissner, Leverkusen (DE); Daniela Portz, Vettweiss (DE); Jean-Pierre Vors, Sainte-Foy-Les-Lyon (FR)

(21) Appl. No.: 14/003,446

(22) PCT Filed: Mar. 9, 2012
(86) PCT No.: PCT/EP2012/054065

§ 371 Date: Sep. 5, 2013

Related U.S. Application Data
(60) Provisional application No. 61/451,262, filed on Mar. 10, 2011.

(30) Foreign Application Priority Data
Mar. 10, 2011 (EP) 11356001.5

(51) Int. Cl. A01N 25/32

(52) U.S. Cl. CPC A01N 25/32
USPC 504/292

(57) ABSTRACT

The present invention relates to the use of lipochito-oligosaccharide derivatives and methods to overcome negative effects of the treatment of seeds with fungicides, insecticides, acaricides or nematicides, particularly on the germination of seeds and vitality of seedlings. The inventive method markedly enhances germination and vitality of seeds that are treated with fungicides, insecticides, acaricides or nematicides.

The present invention relates to the use of lipochito-oligosaccharide derivatives and methods to overcome negative effects of the treatment of seeds with fungicides, insecticides, acaricides or nematicides, particularly on the germination of seeds and vitality of seedlings. The inventive method markedly enhances germination and vitality of seeds that are treated with fungicides, insecticides, acaricides or nematicides.

### BACKGROUND OF THE INVENTION

Fungicides, insecticides, acaricides and nematicides are widely used to prevent or at least decrease damage of unwanted organisms to crops. These chemicals can be applied on the soil before sowing, and/or before and/or after the seedlings have emerged. Fungicides, insecticides, acaricides and nematicides can also be added to the seed as a seed treatment. A seed treatment including a fungicidal, insecticidal, nematicidal or acaricidal active ingredient can include one of these types of compounds only, but can also include a mixture of two or more of compounds. In this document, references to insecticidal seed treatments also relate to seed treatments including a nematicidal or acaricidal active ingredients, as well as to seed treatments including the said mixtures of compounds. The use of seed treatments is a growing market (Halmer, P. 2004. Methods to improve seed performance in the field. In: Handbook of seed physiology. Applications to agriculture. Eds: Benech-Arnold, R. L. and Sanchez, R. A.), because the use of seed treatments has several advantages over the use of spray or granule applications (e.g. Altmann, R. 2003. Pflanzenschutz-Nachrichten Bayer 56(1), pp 102-110; Hewett, P. D. and Griffiths, D. C. 1986. Biology of seed treatment. In: Seed treatment. Ed: Jeffs, K. A.). Seed treatments protect the seed from sowing onwards. Good overall protection in the early growth phase results in healthy and vigorous plants that better tolerate stress situations. In addition, the total amount of product needed is lower than with spray or granule applications. Crop protection by means of seed treatments also includes many advantages for farmers. The need for other pesticidal applications is smaller and the farmers do not need to calculate and prepare tank mixings. Both aspects result in time saving. The moment of spraying crop protection chemicals is very weather dependent, but this problem is not an issue for treated seeds. Agrochemical companies develop formulations especially suitable for the application as a seed treatment. Such formulations can be added to the seed in the form of a film coating. Characteristically, a film coating is a uniform, dust-free, water permeable film, evenly covering the surface of all individual seeds (Halmer, P. 2000. Commercial seed treatment technology. In: Seed technology and its biological basis. Eds: Black, M. and Bewley, J. D.). Besides the formulation, the coating mixture generally also contains other ingredients such as water, glue (typically a polymer), filler materials, pigments and certain additives to improve particular properties of the coating. Several coatings can be combined on a single seed. In this document, ‘seed treatment’ refers to the application of a film coating on seeds including a formulation with at least one insecticidal, acaricidal or nematicidal active ingredient, including also the possibility of using the coating in or on a pellet, as well as including the insecticidal, nematicidal or acaricidal seed treatment formulation directly into the pellet mixture.

Seed pelleting is a technique that is primarily intended to change the natural shape and size of the raw seed, and the technique can be combined with film coating (Halmer, P. 2000. Commercial seed treatment technology. In: Seed technology and its biological basis. Eds: Black, M. and Bewley, J. D.). Pelleting creates round or rounded shapes, which are easily sown with modern sowing machines. A pelleting mixture contains at least glue and filler material. The latter could be, for example, clay, mica, chalk or cellulose. In addition, certain additives can be included to improve particular properties of the pellet. A seed treatment formulation comprising at least one insecticidal, acaricidal or nematicidal compound can be added directly into the pelleting mixture. In addition, several combinations with film coating are possible: the film coating can be added on the outside of the pellet, in between two layers of pelleting material, and directly on the seed before the pelleting material is added. Also more than 1 film coating layer can be incorporated in a single pellet. A special type of pelleting is encrusting. This technique uses less filler material, and the result is a ‘mini-pellet’.

A variety of techniques and machines exist to apply film coatings, and many of these can also be used or adapted for seed pelleting. Manufacturers of seed treatment machines are, for example, Gustafson Equipment, Satec and SUET. Techniques and machines vary in the method of applying the seed treatment mixture to the seed and the blending process (Jeffs, K. A. and Tuppen, R. J. 1986. Applications of pesticides to seeds. Part 1: Requirements for efficient treatment of seeds. In: Seed treatment. Ed: Jeffs, K. A.). The mixture, for example, can be added by means of a spinning disc atomizer or spreading brushes. The seeds and the mixture can be blended by means of an auger, in a drum, or in rotating troughs. If the amount of film coating mixture added is low, and can be absorbed by the seed itself with only a slight (typically less than 1%) increase in seed moisture content, no additional drying step is necessary. This principle is called self-drying (Black et al., 2006. The encyclopedia of seeds. Science, technology and uses). Otherwise, a drying powder (such as talc) could be added, or an additional drying step is necessary. This step could be integrated in the equipment for film coating, such as in the SUET rotary seed treater with integrated fluid bed dryers. Some SATEC batch coaters are equipped to be connected with drying air also.

A disadvantage of the use of crop protection chemicals is the fact that they can negatively affect crop plants themselves, and this also holds for seeds when the chemicals are added as a seed treatment (Halmer, P. 2000. Commercial seed treatment technology. In: Seed technology and its biological basis. Eds: Black, M. and Bewley, J. D.; Halmer, P. 2004. Methods to improve seed performance in the field. In: Handbook of seed physiology. Applications to agriculture. Eds: Benech-Amold, R. L. and Sanchez, R. A.). Seed safety is thus affected. The seed treatment including at least one fungicidal, insecticidal, acaricidal or nematicidal active ingredient might result in a slower and less uniform germination of the treated seeds. They might also be affected in the root or shoot growth. Basically, germination is defined as the moment at which the radicle protrudes the seed coat or the pericarp. In case seeds are sown in substrate fully covering the seeds, germination is defined as the moment at which the seedlings emerge from the substrate (i.e. emergence). Than, a slower germination results in a slower emergence of the seedlings. Throughout the text, the definition of germination of seed stated above is followed, and used interchangeably with the emergence of seedlings, unless stated otherwise. The seed treatment could also influence the maximum germination and the vitality of the seedlings, including the root or shoot development and growth. Vital seedlings are healthy seedlings that can develop in normal yield-producing plants. The seed treatment could result in a lower vitality and even in a higher number of abnormal seedlings or dead seeds. Negative effects of the seed treatment on germination and vitality can be assessed in experiments under controlled conditions in the climate chamber, greenhouse or germination cabinet in the laboratory, as well as in the field.

If negative effects of seed treatments on seed safety occur, these are generally accepted because the benefits of the seed treatment outweigh the costs, but after all they are disadvantageous in modern farming systems. A delay in germination increases the risk (and duration) of the seeds being attacked by disease-causing organisms or soil pests (Jonitz, A. and Leist, N. 2003. Pflanzenschutz-Nachrichten Bayer, 56(1), pp 173-207). A slower and less uniform germination could also affect subsequent spraying treatments. Many herbicides, for example, are most effective at a specific developmental stage of the seedlings. Principally, delayed germination also shortens the growing period of the crop which might lead to reduced yields. Finally, if the vitality of the seedlings is affected, this could result in a decrease of number of marketable plants, which could result in yield loss as well.

The invention includes the use of lipochito-oligosaccharide derivatives and methods to overcome the negative effect, and more particularly to improve the germination of seeds and/or the vitality of seedlings emerging from said seeds, of agricultural, vegetable or flower seeds treated with a seed treatment including at least one fungicidal, insecticidal, acaricidal or nematicidal active ingredient.

### DESCRIPTION OF THE INVENTION

Seed treatments including at least one fungicidal, insecticidal, nematicidal or acaricidal active ingredient thus can affect germination of seeds and vitality of seedlings, including root or shoot development and growth. Surprisingly, we have found that associating a lipochito-oligosaccharide derivative to the at least one fungicidal, insecticidal, nematicidal or acaricidal active ingredient reduces or even removes the negative effects of these seed treatments on germination and vitality.

The invention is applicable to seeds of the crops outlined below. Also included in these lists of crops are hybrids of the said species as well as genetically modified plants of the said species.

The invention can be used successfully on any seed to which a conventional priming process can be applied.

The present invention relates to a method to improve the germination of seed, or the vitality of the seedling emerging from said seed, of an agricultural, vegetable or flower crop treated with a seed treatment containing at least one fungicidal, insecticidal, acaricidal or nematicidal compound, characterized in that said seed treatment contains further a lipochito-oligosaccharide derivative.

In the meaning of the invention, a lipochito-oligosaccharide compound is a compound having the general LCO structure, i.e. an oligomeric backbone of β-1,4-linked N-acetyl-D-glucosamine residues with a lipid chain at the non-reducing end.

Said lipid chain can be an N-linked fatty acyl chain as found in natural lipochito-oligosaccharides (LCO). Apart from these natural LCO compounds, synthetic analogs, such as the ones described in WO 2005/063784 can be advantageously used in the present invention.

LCOs may be isolated directly from a particular culture of Rhizobiaceae bacterial strains, synthesized chemically, or obtained chemo-enzymatically. Via the latter method, the oligosaccharide skeleton may be formed by culturing of recombinant Escherichia coli bacterial strains in a fermenter, and the lipid chain may then be attached chemically.

Natural LCOs are typically compounds with a backbone of 3-6 residues of β-1,4-linked N-acetyl-D-glucosamine, with the N acetyl group of the terminal non-reducing end replaced by an acyl chain with 16 to 20 carbons and a number of double bond varying from 0 to 4. Lipo-chitooligosaccharide compounds having an oligomeric backbone of β-1,4-linked N-acetyl-D-glucosamine residues with a N-linked fatty acyl chain at the non-reducing end have been described in U.S. Pat. No. 5,549,718; U.S. Pat. No. 5,646,018; U.S. Pat. No. 5,175,149; and U.S. Pat. No. 5,321,011.

In particular, suitable LCOs compounds include, but are not limited to, Bj Nod-V (C18:1), Bj Nod-V (Ac, C18:1), Bj Nod-V (C16:0), Bj Nod-V (Ac, C16:0), Bj-Nod-V (C16:1), NodRm, Ac-NodRm and NodNGR. The nomenclature used to describe said LCO compounds is standart in the art and refers to the species which produce said compounds (e.g. Bradyrhizobium japonicum), the number of N-acetylglucosamine residues (e.g. “V”), substitutions on the reducing terminal sugar residue (e.g. “Ac” representing acetyl), and the number of carbons in the acyl chain and degree of unsaturation (e.g. C16:0).

This basic structure may contain modifications or substitutions found in naturally occurring LCO's, such as those described in Spaink, Critical Reviews in Plant Sciences 54: 257-288, 2000; D'Haeze and Holsters, Glycobiology 12: 79R-105R, 2002.

Naturally occurring LCO's are defined as compounds which can be found in nature. For the purpose of the invention, said naturally occurring LCO's may be isolated from the natural organism, or can be a partial or totally synthetic version of said naturally occurring LCO.

This basic structure may also contain modifications or substitutions which have not been found so far in naturally occurring LCO's. Examples of such analogs for which the conjugated amide bond is mimicked by a benzamide bond or which contain a function of benzylamine type are the following compounds of formula (I) which are described in WO2005/063784 and WO2008/071672, the content of which is incorporated herein by reference.

In a particular embodiment of the invention, lipo-chitooligosaccharide compounds according to the invention encompass compounds of formula (I):

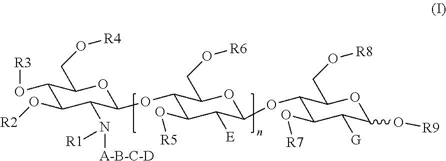

in which
n represents 1, 2 or 3;
A represents a substituent chosen from —C(O)—, —C(S)—, —CH2-, —CHR10-, —CR10R11-, —C(O)O—, —C(O)S—, —C(S)O—, —C(S)S—, —C(O)NH—, —C(NH)NH— and —C(S)NH—;
B represents
   an arylene;
   a heteroarylene comprising 1 or 2 hetero atoms chosen from nitrogen, oxygen and sulfur;
   a naphthylene;
   a heteronaphthylene comprising 1 or 2 hetero atoms chosen from nitrogen, oxygen and sulfur;
   a divalent radical derived from 2 fused aromatic rings of 5 or 6 atoms each;
   a divalent radical derived from 2 fused aromatic or heteroaromatic rings of 5 or 6 atoms each, comprising 1 or 2 hetero atoms chosen from nitrogen, oxygen and sulfur;
   a biphenylene;
   or a heterobiphenylene comprising 1 or 2 hetero atoms chosen from nitrogen, oxygen and sulfur;
these groups possibly being substituted with one or two substituents R12 and R13 chosen, independently of each other, from halogen, CN, C(O)OR14, C(O)NR15R16, CF3, OCF3, —NO2, N3, OR14, SR14, NR15R16 and C1-6-alkyl;
C represents a substituent chosen from —O—, —S—, —CH2-, —CHR17-, —CR17R18- and —NR19;
D represents a linear or branched, saturated or unsaturated hydrocarbon-based chain containing from 2 to 20 carbon atoms;
E and G represent, independently of each other, a substituent chosen from H, OH, OR20, NH2 and NHR20;
R1 represents a substituent chosen from H, C1-6-alkyl, C(O)H and C(O)CH3;
R2, R3, R6, R14, R15, R16 and R19 represent, independently of each other, a substituent chosen from H, C1-6-alkyl, C(O)C1-6-alkyl, —C(S)C1-6-alkyl, —C(O)OC1-6-alkyl, —C(O)NH2, —C(S)NH2, —C(NH)NH2, —C(O)NHC1-6-alkyl, —C(S)NHC1-6-alkyl and —C(NH)NHC1-6-alkyl;
R4 represents a substituent chosen from H, C1-6-alkyl and R21;
R5 represents a substituent chosen from H, C1-6-alkyl, fucosyl and R22;
R7 represents a substituent chosen from H, C1-6-alkyl, arabinosyl and R23;
R8 represents a substituent chosen from H, C1-6-alkyl, fucosyl, methylfucosyl, sulfofucosyl, acetylfucosyl, arabinosyl, SO3H, SO3Li, SO3Na, SO3K, SO3N(C1-8alkyl)₄ and R24;
R9 represents a substituent chosen from H, C1-6-alkyl, mannose, glycerol and R25;
R10, R11, R17 and R18 represent, independently of each other, a substituent chosen from C1-6-alkyl and F;
R20, R21, R22, R²³, R²⁴ and R²⁵ represent, independently of each other, a substituent chosen from C(O)C1-6-alkyl, —C(S)C1-6-alkyl, —C(O)OC1-6-alkyl, —C(O)NH2, —C(S)NH2, —C(NH)NH2, —C(O)NHC1-6-alkyl, —C(S)NHC1-6-alkyl and —C(NH)NHC1-6-alkyl;
   and also the possible geometrical and/or optical isomers, enantiomers and/or diastereoisomers, tautomers, salts, N-oxides, sulfoxides, sulfones, metal or metalloid complexes thereof, which are agriculturally acceptable. Among the compounds defined above, the most important compounds are the salts, more particularly the lithium, sodium, potassium or tetraalkylammonium salts;

Among these compounds of formula (I), these ones which have one or other of the following characteristics, taken separately or in combination, may be particularly advantageous:
n represents 2 or 3;
A represents —C(O)—;
B represents a phenylene;
C represents —O—;
D represents a linear hydrocarbon-based chain containing 11 carbons, which is saturated, or unsaturated between carbons 4 and 5;
E and G represent NHC(O)CH₃;
R¹ represents H, CH₃ or C(O)CH₃;
R², R³, R⁵, R⁶, R⁷ and R⁹ represent H;
R⁴ represents H, C(O)CH₃ or C(O)NH₂;
R⁸ represents H, SO₃H, SO₃L₁, SO₃Na, SO₃K, SO₃N(C₁₋₈alkyl)₄, fucosyl or methylfucosyl.

As examples of compositions according to the invention that are particularly advantageous and preferred, mention may be made of the compositions comprising a compound corresponding to one of the following formulae:

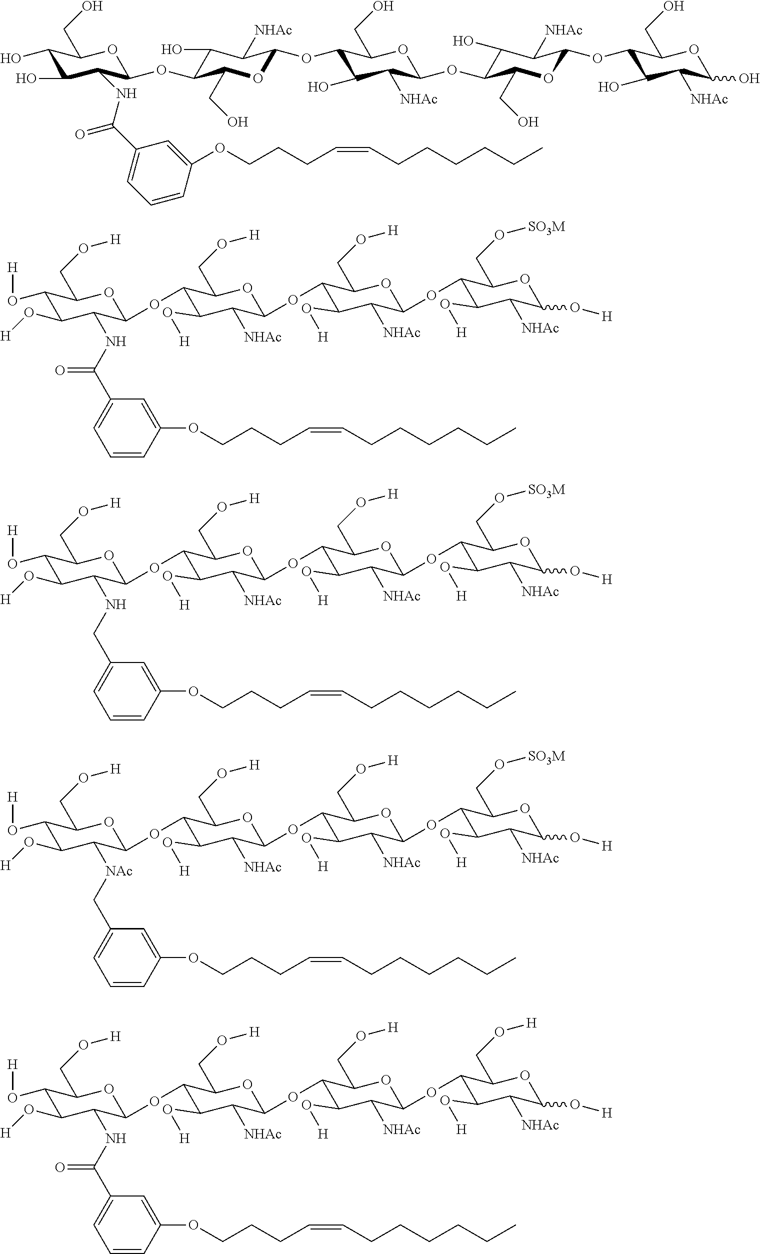

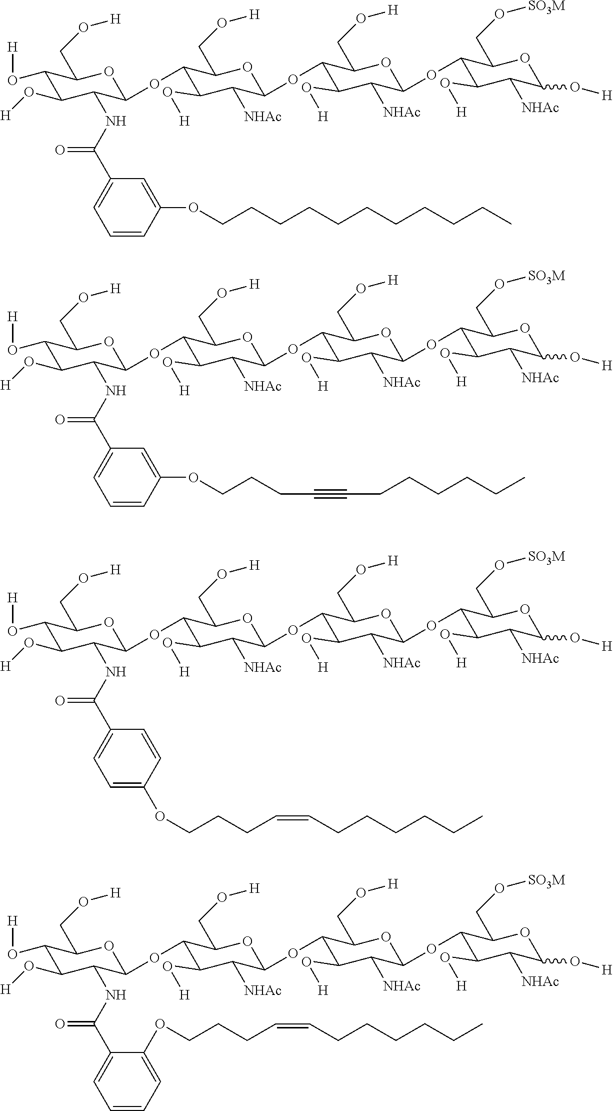

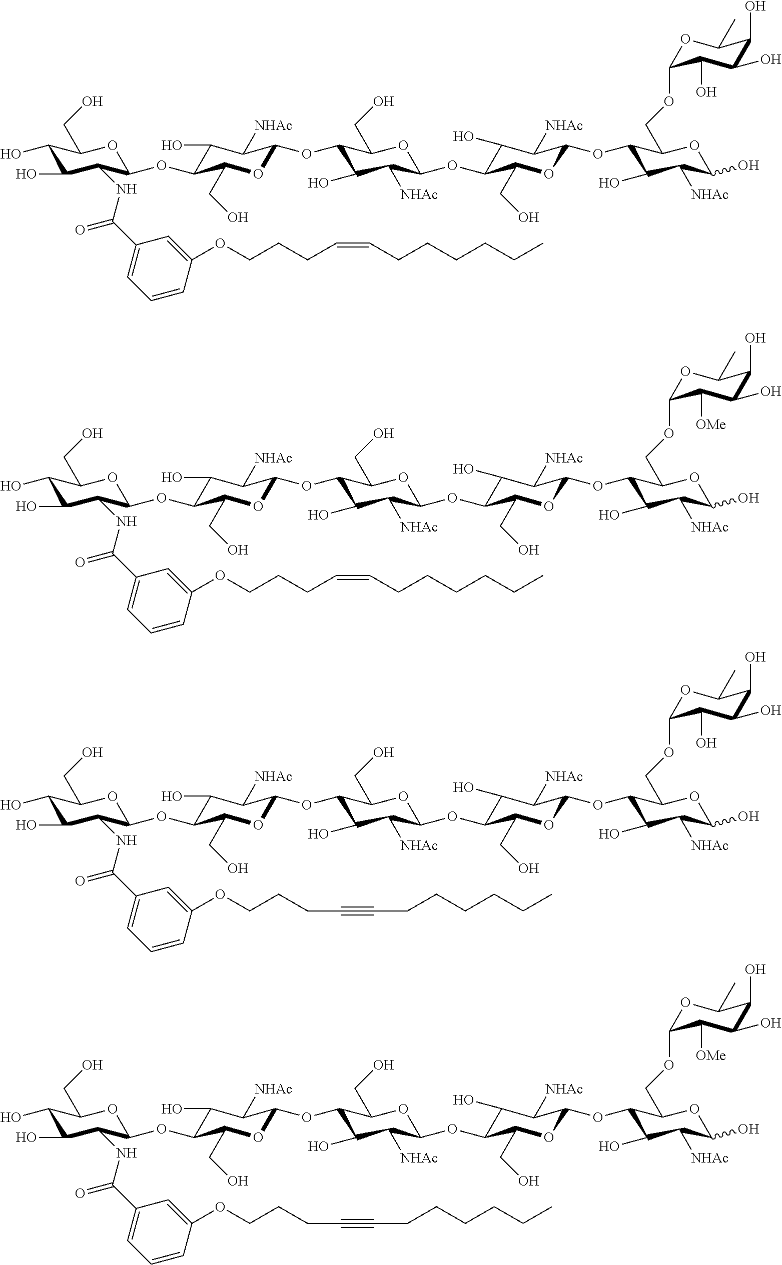

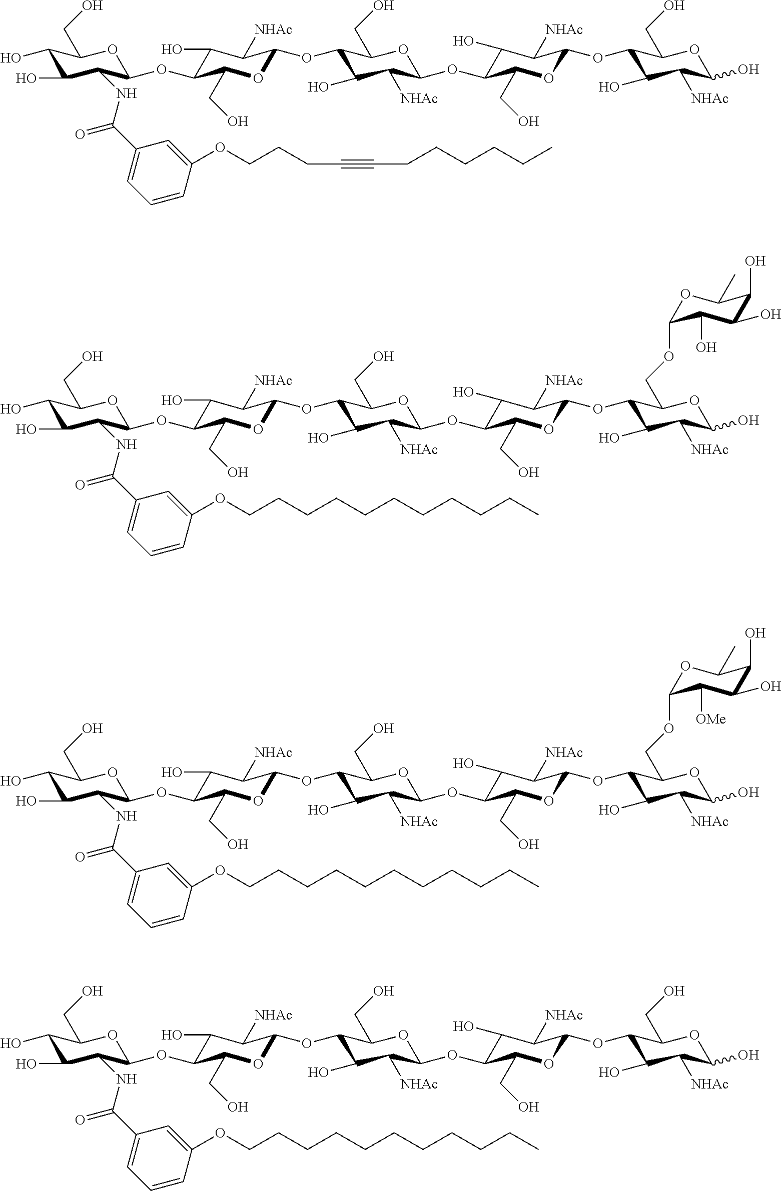

in which, when it is present, M represents a cation chosen from H⁺, Li⁺, Na⁺, K⁺ and (C₁₋₈alkyl)₄N⁺.

The LCO's compounds may be isolated directly from a particular culture of Rhizobiaceae bacterial strains, synthesized chemically, or obtained chemo-enzymatically. Via the latter method, the oligosaccharide skeleton may be formed by culturing of recombinant bacterial strains, such as Escherichia coli, in a fermenter, and the lipid chain may then be attached chemically.

LCO's used in embodiments of the invention may be recovered from natural Rhizobiaceae bacterial strains that produce LCO's, such as strains of Azorhizobium, Bradyrhizobium (including B. japonicum), Mesorhizobium, Rhizobium (including R. leguminosarum), Sinorhizobium (including S. meliloti), or from bacterial strains genetically engineered to produce LCO's. These methods are known in the art and have been described, for example, in U.S. Pat. Nos. 5,549,718 and 5,646,018, which are incorporated herein by reference.

LCO's may be utilized in various forms of purity and may be used alone or with rhizobia. Methods to provide only LCO's include simply removing the rhizobial cells from a mixture of LCOs and rhizobia, or continuing to isolate and purify the LCO molecules through LCO solvent phase separation followed by HPLC chromatography as described by Lerouge, et. al (U.S. Pat. No. 5,549,718). Purification can be enhanced by repeated HPLC, and the purified LCO molecules can be freeze-dried for long-term storage. This method is acceptable for the production of LCO's from all genera and species of the Rhizobiaceae.

Commercial products containing LCO's are available, such as OPTIMIZE® (EMD Crop BioScience).

LCO compounds, which can be identical or not to naturally occurring LCO's, may also be obtained by chemical synthesis and/or through genetic engineering. Synthesis of precursor oligosaccharide molecules for the construction of LCO by genetically engineered organisms is disclosed in Samain et al., Carbohydrate Research 302: 35-42, 1997.

Preparation of numerous LCOs compounds wherein the oligosaccharide skeleton is obtained by culturing recombinant bacterial strains, such as recombinant Escherichia coli cells harboring heterologous gene from rhizobia, and wherein the lipid chain is chemically attached is disclosed in WO2005/063784 and WO2008/07167, the content of which is incorporated herein by reference.

Specifically, the invention is applicable to seeds of the genera of the following agricultural crops: Arachis, Avena, Brassica, Carthamus, Glycine, Gossypium, Helianthus, Hordeum, Lolium, Medicago, Oryza, Poa, Secale, Sorghum, Trifolium, Triticum and Zea. Also included is Triticale. Particularly preferred genera of agricultural crops are: Brassica, Gossypium, Helianthus, Oryza and Zea. The most preferred genera of agricultural crops are: Brassica, Gossypium, and Zea.

Further, the invention can specifically be applied to the genus of Beta, and in particular to sugarbeets (Beta vulgaris).

For the vegetable crops, the invention is specifically applicable to seeds of: Allium, Apium, Asparagus, Brassica, Capsicum, Cicer, Cichorium, Citrillus, Cucumis, Cucurbita, Cynara, Daucus, Lactuca, Lens, Phaseolus, Pisum, Raphanus, Solanum (including tomato, also frequently indicated as Lycopersicon esculentum), Spinacia, Valerianella and Vicia. For the vegetable crops, particularly preferred genera are: Allium, Brassica, Capsicum, Citrillus, Cucumis, Cucurbita, Daucus, Lactuca and Solanum. Most preferred genera of vegetable crops are: Allium, Capsicum, Cucumis, Daucus, Lactuca and Solanum. Further most preferred genera of vegetable crops are: Allium, Brassica, Daucus, Lactuca and Solanum.

Specifically, the invention is applicable to seeds of the genera of the following flower crops: Antirrhinum, Begonia, Chrysanthemum, Cyclamen, Dianthus, Gazania, Gerbera, Impatiens, Ipomoea, Lavatera, Lobelia, Pelargonium, Petunia, Phlox, Primula, Salvia, Tageta, Verbena, Vinca, Viola and Zinnia. Particularly preferred flower crops are: Cyclamen, Dianthus, Impatiens, Pelargonium, Petunia, Primula, Tageta, Verbena and Viola. The most preferred flower crops are: Dianthus, Impatiens, Pelargonium, Petunia, Tageta and Verbena.

In a particular embodiment of the invention, seed treatment includes further a priming treatment, i.e. hydration and drying of the seed prior to the application of the composition comprising a chito-oligosaccharide derivatives as herein defined and an insecticidal, acaricidal, or nematicidal compounds.

In a particular embodiment of the invention, the method of the invention comprises the following steps:

1) Hydration of the seed
2) Followed by drying of the seed
3) Followed by a treatment of the seed with a composition comprising a chito-oligosaccharide derivatives as herein defined and an insecticidal, acaricidal, or nematicidal compounds

The seeds that are hydrated and dried before coating with the said chemical seed treatments benefit of the hydration and drying treatment, as well as of the protection of the chemical seed treatment. ‘Hydrating’ the seed includes all techniques that make seeds absorb water; from soaking in abundant water for a short time period to controllably adding a specific amount of water for several weeks. Seed hydration techniques thus also include those techniques generally included in the concept of priming. Seed priming is defined as the uptake of water by seeds to initiate the early events of germination but not sufficient to permit radicle protrusion, followed by drying (McDonald, M. B. 2000. Seed priming. In: Seed technology and its biological basis. Eds: Black, M. and Bewley, J. D.). ‘Water’ in this document could be all kinds of water including tap water, rainwater and distilled water. Water in the form of water vapour is also included. Important factors influencing the outcome of a hydration procedure are duration, temperature and the matric or osmotic potential of the priming medium. In addition, light or darkness and the amount of oxidation also influence the outcome of the hydration method.

During the hydration stage, water is taken up by the seed causing enzyme systems and other cellular components to be stimulated and created (McDonald, M. B. 2000. Seed priming. In: Seed technology and its biological basis. Eds: Black, M. and Bewley, J. D.). In this way the seeds have already fulfilled parts of the first phases of germination, resulting in a faster germination upon rewetting. In addition, the hydration treatment results in a more uniform germination because all seeds are at the same stage of development. The addition of promotive substances during priming, and thus generally during hydration, can further enhance seed performance, such as fungicides, biological control organisms and plant growth regulators. Fungicides can be added during the priming procedure in order to prevent excessive growth of fungi at favourable conditions in the priming medium.

Several techniques for seed priming are currently known, namely hydropriming (including drum priming), osmopriming and solid matrix priming (McDonald, M. B. 2000. Seed priming. In: Seed technology and its biological basis. Eds: Black, M. and Bewley, J. D.; Black et al., 2006. The encyclopedia of seeds. Science, technology and uses). Priming is also sometimes referred to as seed conditioning.
Hydropriming includes those techniques in which seeds are allowed to take up water for a short period or at low temperatures, mostly at ample water supply. These techniques are sometimes also referred to as soaking or steeping. The short duration or low temperature ensures that no germination takes place. Durations of the hydropriming procedure range between 0.5 and 60 hours, at temperatures between 5-50° C. Preferred durations are between 1 and 24 hours at temperatures between 10 and 30° C. Alternatively preferred durations are between 1 and 48 hours. Particularly preferred durations for hydropriming are between 4 and 16 hours at temperatures of 15 to 25° C. Alternatively, particularly preferred ranges for hydropriming are durations between 4 and 32 hours, and temperatures between 15 to 20° C. Hydropriming also includes those techniques that involve the continuous or staged addition of a limited amount of water. A sophisticated form of this concept is drum priming. Seeds are kept in a rotating drum, in which a limited amount of water (or water vapour) is slowly added to the seeds. The limited amount of water controls the extent of priming. Generally, the duration of a drum priming procedure ranges from 1 to 21 days, at temperatures between 5 and 30° C. Preferred durations range between 5 and 17 days, at temperatures between 10 and 30° C. Particularly preferred durations for drum priming are between 7 and 14 days, at a temperatures range of 15-25° C.
With osmopriming, the seeds are exposed to an osmotic solution. This could be carried out, for example, on a blotter, or in a container or (aerated) column. Polyethyleneglycol (PEG) is often used as osmoticum. Other types of osmotica are inorganic salts such as KH₂PO₄, KH(PO₄)₂, K₃PO₄, KCL, KNO₃ and Ca(NO₃)₂ (sometimes these techniques are referred to as saltpriming or halopriming), or mannitol. Due to its low water potential, the osmoticum controls the uptake of water in the seed. Generally, durations of the osmopriming procedure range from 1 to 21 days, at temperatures between 5 and 30° C. and with osmotic potentials between −0.4 and −3.6 MPa. Preferably, osmopriming durations are between 3 and 15 days at temperatures of 10-30° C. and at osmotic potentials of between −0.5 and −2.6 MPa. Alternative preferred durations are between 2 and 15 days exposure. Particularly preferred durations for osmopriming are between 7 and 14 days, at temperatures between 15 and 25° C., and at osmotic potentials of between −1 and −2 MPa. Alternatively, particularly preferred ranges for osmopriming are durations between 0.5 and 14 days, temperatures between 15 and 20° C., and at osmotic potentials between −0.5 and −2.0 Mpa.
With solid matrix priming (SMP), seeds are mixed with water and solid carriers. Examples of solid carriers are vermiculite and diatomaceous silica products. The water is taken up by the seeds as well as absorbed on the solid particle surfaces, which in this way control the water uptake of the seeds. In addition to using particle-like carriers, SMP can be carried out using, amongst others, moist towels, gunny bags, moist sand, sterilised compost or press mud as well. Generally, durations of the SMP procedure range from 1 to 21 days, at temperatures between 5 and 30° C. and with osmotic potentials between −0.4 and −3.6 MPa. Preferably, SMP durations are between 3 and 15 days at temperatures of 10-30° C. and at osmotic potentials of between −0.5 and −2.6 MPa. Particularly preferred durations for SMP are between 7 and 14 days, at temperatures between 15 and 25° C., and at osmotic potentials of between −1 and −2 MPa. Alternatively, particularly preferred ranges for SMP are durations between 8 hours and 7 days, at temperatures between 15 and 20° C., at osmotic potentials between −1 and −2 Mpa.

Although osmotic potentials can be measured and indicated for SMP protocols, giving the ratio of seed:carrier material:water is more common. Many ratios are possible, depending on, for example, seed size, carrier material and the target moisture uptake of the seeds. If the amount (volume or weight) of seed is taken as 1, the amount of carrier material could range, for example, from 0.25 to 3. Then the amount of water could, for example, range from 0.50 to 8. A ratio of seed:carrier:water of 1:2:2.5 is often used. Alternatively, particularly preferred ranges for SMP are durations between 8 hours and 7 days, at temperatures between 15 and 20° C., at a seed:carrier:water ratio of 1:2:2.5. Other techniques included in the invention are humidification and hardening. These techniques are not always strictly included within the priming definition, but are included in the concept of hydrating and drying seeds. Humidification is a technique in which seeds are exposed to moist air. The used air humidity is generally high, typically between 95 and 100%. The technique is particularly suitable for large seeded species which are highly susceptible to imbibitional damage. Hardening is a technique in which the seeds are exposed to successive hydration and drying cycles (typically 2 to 3), and can also result in germination advancement.

After hydration of the seeds, a drying step is necessary to be able to apply the seed treatment on the seeds successfully and practically. Besides, without drying, the chemical seed treatment might penetrate the seed and be still harmful for the seed and the seedling. Preferably, the seeds are dried to a moisture content between 3 and 15% on a fresh weight basis. Generally, this is the moisture content reached after drying following harvesting. Thus in most cases, the seeds are dried back (redried) to their moisture content before hydration. There are numerous methods known in the art that could be applied for drying, such as drying in still air, in enforced air, in fluidized beds, by means of centrifugation or by sun drying (Black et al., 2006. The encyclopedia of seeds. Science, technology and uses). Many factors influence the seed drying process, such as the surrounding air humidity and temperature, the moisture content of the seed, the plant species involved, and, if applicable, air flow. Techniques including warm air drying are used often in commercial seed drying. Generally, good results will be achieved at air temperatures between 20-50° C. and at relative air humidities between 20-60%. Durations are very method dependent and range from several hours to several days. Seeds could also be dried by means of artificial desiccants (e.g. silica gel or calcium chloride).

There is a need to treat crops with fungicides or insecticides, and seed treatment insecticides or fungicides are used increasingly. Our invention, eventually coupled with a priming treatment, offers the possibility to include fungicides, insecticides, nematicides and acaricides in a seed treatment without decreasing seed quality and emergence. It safeguards a rapid, typically early, growth which is a prerequisite to exploit a varieties' yield potential to the full. In addition, the invention increases the possibilities for the use of seed treatment fungicides or insecticides in many crops. This is advantageous because the use of seed treatments has many advantages over the use of spray or granule applications. Due to the invention, the number of species and varieties that can be treated with a chemical seed treatment increases. Before, some varieties could not be treated because they were too sensitive to chemical seed treatments. Besides, our invention offers possibilities for the development of chemicals to be used as seed treatment including at least one insecticidal, nematicidal or acaricidal compound. Certain active ingredients that could not be used as a seed treatment before, due to their negative effect on the seed, can now be included.

The inventive method can be used in particular with the following groups of fungicides:

(1) Inhibitors of the ergosterol biosynthesis, for example (1.1) aldimorph (1704-28-5), (1.2) azaconazole (60207-31-0), (1.3) bitertanol (55179-31-2), (1.4) bromuconazole (116255-48-2), (1.5) cyproconazole (113096-99-4), (1.6) diclobutrazole (75736-33-3), (1.7) difenoconazole (119446-68-3), (1.8) diniconazole (83657-24-3), (1.9) diniconazole-M (83657-18-5), (1.10) dodemorph (1593-77-7), (1.11) dodemorph acetate (31717-87-0), (1.12) epoxiconazole (106325-08-0), (1.13) etaconazole (60207-93-4), (1.14) fenarimol (60168-88-9), (1.15) fenbuconazole (114369-43-6), (1.16) fenhexamid (126833-17-8), (1.17) fenpropidin (67306-00-7), (1.18) fenpropimorph (67306-03-0), (1.19) fluquinconazole (136426-54-5), (1.20) flurprimidol (56425-91-3), (1.21) flusilazole (85509-19-9), (1.22) flutriafol (76674-21-0), (1.23) furconazole (112839-33-5), (1.24) furconazole-cis (112839-32-4), (1.25) hexaconazole (79983-71-4), (1.26) imazalil (60534-80-7), (1.27) imazalil sulfate (58594-72-2), (1.28) imibenconazole (86598-92-7), (1.29) ipconazole (125225-28-7), (1.30) metconazole (125116-23-6), (1.31) myclobutanil (88671-89-0), (1.32) naftifine (65472-88-0), (1.33) nuarimol (63284-71-9), (1.34) oxpoconazole (174212-12-5), (1.35) paclobutrazol (76738-62-0), (1.36) pefurazoate (101903-30-4), (1.37) penconazole (66246-88-6), (1.38) piperalin (3478-94-2), (1.39) prochloraz (67747-09-5), (1.40) propiconazole (60207-90-1), (1.41) prothioconazole (178928-70-6), (1.42) pyributicarb (88678-67-5), (1.43) pyrifenox (88283-41-4), (1.44) quinconazole (103970-75-8), (1.45) simeconazole (149508-90-7), (1.46) spiroxamine (118134-30-8), (1.47) tebuconazole (107534-96-3), (1.48) terbinafine (91161-71-6), (1.49) tetraconazole (112281-77-3), (1.50) triadimefon (43121-43-3), (1.51) triadimenol (89482-17-7), (1.52) tridemorph (81412-43-3), (1.53) triflumizole (68694-11-1), (1.54) triforine (26644-46-2), (1.55) triticonazole (131983-72-7), (1.56) uniconazole (83657-22-1), (1.57) uniconazole-p (83657-17-4), (1.58) viniconazole (77174-66-4), (1.59) voriconazole (137234-62-9), (1.60) 1-(4-chlorophenyl)-2-(1H-1,2,4-triazol-1-yl)cycloheptanol (129586-32-9), (1.61) methyl 1-(2,2-dimethyl-2,3-dihydro-1H-inden-1-yl)-1H-imidazole-5-carboxylate (110323-95-0), (1.62) N′-{5-(difluoromethyl)-2-methyl-4-[3-(trimethylsilyl)propoxy]phenyl}-N-ethyl-N-methylimidoformamide, (1.63) N-ethyl-N-methyl-N′-{2-methyl-5-(trifluoromethyl)-4-[3-(trimethylsilyl)propoxy]phenyl}imidoformamide, (1.64) O-[1-(4-methoxyphenoxy)-3,3-dimethylbutan-2-yl] 1H-imidazole-1-carbothioate (111226-71-2).

(2) inhibitors of the respiratory chain at complex I or II, for example (2.1) bixafen (581809-46-3), (2.2) boscalid (188425-85-6), (2.3) carboxin (5234-68-4), (2.4) diflumetorim (130339-07-0), (2.5) fenfuram (24691-80-3), (2.6) fluopyram (658066-35-4), (2.7) flutolanil (66332-96-5), (2.8) fluxapyroxad (907204-31-3), (2.9) furametpyr (123572-88-3), (2.10) furmecyclox (60568-05-0), (2.11) isopyrazam (mixture of syn-epimeric racemate 1RS,4SR,9RS and anti-epimeric racemate 1RS,4SR,9SR) (881685-58-1), (2.12) isopyrazam (anti-epimeric racemate 1RS,4SR,9SR), (2.13) isopyrazam (anti-epimeric enantiomer 1R,4S,9S), (2.14) isopyrazam (anti-epimeric enantiomer 1S,4R,9R), (2.15) isopyrazam (syn epimeric racemate 1RS,4SR,9RS), (2.16) isopyrazam (syn-epimeric enantiomer 1R,4S,9R), (2.17) isopyrazam (syn-epimeric enantiomer 1S,4R,9S), (2.18) mepronil (55814-41-0), (2.19) oxycarboxin (5259-88-1), (2.20) penflufen (494793-67-8), (2.21) penthiopyrad (183675-82-3), (2.22) sedaxane (874967-67-6), (2.23) thifluzamide (130000-40-7), (2.24) 1-methyl-N-[2-(1,1,2,2-tetrafluoroethoxy)phenyl]-3-(trifluoromethyl)-1H-pyrazole-4-carboxamide, (2.25) 3-(difluoromethyl)-1-methyl-N-[2-(1,1,2,2-tetrafluoroethoxy)phenyl]-1H-pyrazole-4-carboxamide, (2.26) 3-(difluoromethyl)-N-[4-fluoro-2-(1,1,2,3,3,3-hexafluoropropoxy)phenyl]-1-methyl-1H-pyrazole-4-carboxamide, (2.27) N-[1-(2,4-dichlorophenyl)-1-methoxypropan-2-yl]-3-(difluoromethyl)-1-methyl-1H-pyrazole-4-carboxamide (1092400-95-7), (2.28) 5,8-difluoro-N-[2-(2-fluoro-4-{[4-(trifluoromethyl)pyridin-2-yl]oxy}phenyl)ethyl]quinazolin-4-amine (1210070-84-0), (2.29) benzovindiflupyr, (2.30) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.31) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.32) 3-(Difluormethyl)-1-methyl-N-(1,1,3-trimethyl-2,3-dihydro-1H-inden-4-yl)-1H-pyrazol-4-carboxamid, (2.33) 1,3,5-Trimethyl-N-(1,1,3-trimethyl-2,3-dihydro-1H-inden-4-yl)-1H-pyrazol-4-carboxamid, (2.34) 1-Methyl-3-(trifluormethyl)-N-(1,3,3-trimethyl-2,3-dihydro-1H-inden-4-yl)-1H-pyrazol-4-carboxamid, (2.35) 1-Methyl-3-(trifluormethyl)-N-[(1S)-1,3,3-trimethyl-2,3-dihydro-1H-inden-4-yl]-1H-pyrazol-4-carboxamid, (2.36) 1-Methyl-3-(trifluormethyl)-N-[(1R)-1,3,3-trimethyl-2,3-dihydro-1H-inden-4-yl]-1H-pyrazol-4-carboxamid, (2.37) 3-(Difluormethyl)-1-methyl-N-[(3S)-1,1,3-trimethyl-2,3-dihydro-1H-inden-4-yl]-1H-pyrazol-4-carboxamid, (2.38) 3-(Difluormethyl)-1-methyl-N-[(3R)-1,1,3-trimethyl-2,3-dihydro-1H-inden-4-yl]-1H-pyrazol-4-carboxamid, (2.39) 1,3,5-Trimethyl-N-[(3R)-1,1,3-trimethyl-2,3-dihydro-1H-inden-4-yl]-1H-pyrazol-4-carboxamid, (2.40) 1,3,5-Trimethyl-N-[(3S)-1,1,3-trimethyl-2,3-dihydro-1H-inden-4-yl]-1H-pyrazol-4-carboxamid.

(3) inhibitors of the respiratory chain at complex III, for example (3.1) ametoctradin (865318-97-4), (3.2) amisulbrom (348635-87-0), (3.3) azoxystrobin (131860-33-8), (3.4) cyazofamid (120116-88-3), (3.5) coumethoxystrobin (850881-30-0), (3.6) coumoxystrobin (850881-70-8), (3.7) dimoxystrobin (141600-52-4), (3.8) enestroburin (238410-11-2), (3.9) famoxadone (131807-57-3), (3.10) fenamidone (161326-34-7), (3.11) fenoxystrobin (918162-02-4), (3.12) fluoxastrobin (361377-29-9), (3.13) kresoxim-methyl (143390-89-0), (3.14) metominostrobin (133408-50-1), (3.15) orysastrobin (189892-69-1), (3.16) picoxystrobin (117428-22-5), (3.17) pyraclostrobin (175013-18-0), (3.18) pyrametostrobin (915410-70-7), (3.19) pyraoxystrobin (862588-11-2), (3.20) pyribencarb (799247-52-2), (3.21) triclopyricarb (902760-40-1), (3.22) trifloxystrobin (141517-21-7), (3.23) (2E)-2-(2-{[6-(3-chloro-2-methylphenoxy)-5-fluoropyrimidin-4-yl]oxy}phenyl)-2-(methoxyimino)-N-methylethanamide, (3.24) (2E)-2-(methoxyimino)-N-methyl-2-(2-{[({(1E)-1-[3-(trifluoromethyl)phenyl]ethylidene}amino)oxy]methyl}phenyl)ethanamide, (3.25) (2E)-2-(methoxyimino)-N-methyl-2-{2-[(1E)-({1-[3-(trifluoromethyl)phenyl]ethoxy}imino)methyl]phenyl}ethanamide (158169-73-4), (3.26) (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide (326896-28-0), (3.27) (2E)-2-{2-[({[(2E,3E)-4-(2,6-dichlorophenyl)but-3-en-2-ylidene]amino}oxy)methyl]phenyl}-2-(methoxyimino)-N-methylethanamide, (3.28) 2-chloro-N-(1,1,3-trimethyl-2,3-dihydro-1H-inden-4-yl)pyridine-3-carboxamide (119899-14-8), (3.29) 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, (3.30) methyl (2E)-2-{2-[({cyclopropyl[(4-methoxyphenyl)imino]methyl}sulfanyl)methyl]phenyl}-3-methoxyprop-2-enoate (149601-03-6), (3.31) N-(3-ethyl-3,5,5-trimethylcyclohexyl)-3-(formylamino)-2-hydroxybenzamide (226551-21-9), (3.32) 2-{2-[(2,5-dimethylphenoxy)methyl]phenyl}-2-methoxy-N-methylacetamide (173662-97-0), (3.33) (2R)-2-{2-[(2,5-dimethylphenoxy)methyl]phenyl}-2-methoxy-N-methylacetamide (394657-24-0).

(4) Inhibitors of the mitosis and cell division, for example (4.1) benomyl (17804-35-2), (4.2) carbendazim (10605-21-7), (4.3) chlorfenazole (3574-96-7), (4.4) diethofencarb (87130-20-9), (4.5) ethaboxam (162650-77-3), (4.6) fluopicolide (239110-15-7), (4.7) fuberidazole (3878-19-1), (4.8) pencycuron (66063-05-6), (4.9) thiabendazole (148-79-8), (4.10) thiophanate-methyl (23564-05-8), (4.11) thiophanate (23564-06-9), (4.12) zoxamide (156052-68-5), (4.13) 5-chloro-7-(4-methylpiperidin-1-yl)-6-(2,4,6-trifluorophenyl)[1,2,4]triazolo[1,5-a]pyrimidine (214706-53-3), (4.14) 3-chloro-5-(6-chloropyridin-3-yl)-6-methyl-4-(2,4,6-trifluorophenyl)pyridazine (1002756-87-7).

(5) Compounds capable to have a multisite action, like for example (5.1) bordeaux mixture (8011-63-0), (5.2) captafol (2425-06-1), (5.3) captan (133-06-2), (5.4) chlorothalonil (1897-45-6), (5.5) copper hydroxide (20427-59-2), (5.6) copper naphthenate (1338-02-9), (5.7) copper oxide (1317-39-1), (5.8) copper oxychloride (1332-40-7), (5.9) copper(2+) sulfate (7758-98-7), (5.10) dichlofluanid (1085-98-9), (5.11) dithianon (3347-22-6), (5.12) dodine (2439-10-3), (5.13) dodine free base, (5.14) ferbam (14484-64-1), (5.15) fluorofolpet (719-96-0), (5.16) folpet (133-07-3), (5.17) guazatine (108173-90-6), (5.18) guazatine acetate, (5.19) iminoctadine (13516-27-3), (5.20) iminoctadine albesilate (169202-06-6), (5.21) iminoctadine triacetate (57520-17-9), (5.22) mancopper (53988-93-5), (5.23) mancozeb (8018-01-7), (5.24) maneb (12427-38-2), (5.25) metiram (9006-42-2), (5.26) metiram zinc (9006-42-2), (5.27) oxine-copper (10380-28-6), (5.28) propamidine (104-32-5), (5.29) propineb (12071-83-9), (5.30) sulphur and sulphur preparations including calcium polysulphide (7704-34-9), (5.31) thiram (137-26-8), (5.32) tolylfluanid (731-27-1), (5.33) zineb (12122-67-7), (5.34) ziram (137-30-4).

(6) Compounds capable to induce a host defence, like for example (6.1) acibenzolar-S-methyl (135158-54-2), (6.2) isotianil (224049-04-1), (6.3) probenazole (27605-76-1), (6.4) tiadinil (223580-51-6).

(7) Inhibitors of the amino acid and/or protein biosynthesis, for example (7.1) andoprim (23951-85-1), (7.2) blasticidin-S (2079-00-7), (7.3) cyprodinil (121552-61-2), (7.4) kasugamycin (6980-18-3), (7.5) kasugamycin hydrochloride hydrate (19408-46-9), (7.6) mepanipyrim (110235-47-7), (7.7) pyrimethanil (53112-28-0), (7.8) 3-(5-fluoro-3,3,4,4-tetramethyl-3,4-dihydroisoquinolin-1-yl)quinoline (861647-32-7).

(8) Inhibitors of the ATP production, for example (8.1) fentin acetate (900-95-8), (8.2) fentin chloride (639-58-7), (8.3) fentin hydroxide (76-87-9), (8.4) silthiofam (175217-20-6).

(9) Inhibitors of the cell wall synthesis, for example (9.1) benthiavalicarb (177406-68-7), (9.2) dimethomorph (110488-70-5), (9.3) flumorph (211867-47-9), (9.4) iprovalicarb (140923-17-7), (9.5) mandipropamid (374726-62-2), (9.6) polyoxins (11113-80-7), (9.7) polyoxorim (22976-86-9), (9.8) validamycin A (37248-47-8), (9.9) valifenalate (283159-94-4; 283159-90-0).

(10) Inhibitors of the lipid and membrane synthesis, for example (10.1) biphenyl (92-52-4), (10.2) chloroneb (2675-77-6), (10.3) dicloran (99-30-9), (10.4) edifenphos (17109-49-8), (10.5) etridiazole (2593-15-9), (10.6) iodocarb (55406-53-6), (10.7) iprobenfos (26087-47-8), (10.8) isoprothiolane (50512-35-1), (10.9) propamocarb (25606-41-1), (10.10) propamocarb hydrochloride (25606-41-1), (10.11) prothiocarb (19622-08-3), (10.12) pyrazophos (13457-18-6), (10.13) quintozene (82-68-8), (10.14) tecnazene (117-18-0), (10.15) tolclofos-methyl (57018-04-9).

(11) Inhibitors of the melanine biosynthesis, for example (11.1) carpropamid (104030-54-8), (11.2) diclocymet (139920-32-4), (11.3) fenoxanil (115852-48-7), (11.4) phthalide (27355-22-2), (11.5) pyroquilon (57369-32-1), (11.6) tricyclazole (41814-78-2), (11.7) 2,2,2-trifluoroethyl {3-methyl-1-[(4-methylbenzoyl)amino]butan-2-yl}carbamate (851524-22-6).

(12) Inhibitors of the nucleic acid synthesis, for example (12.1) benalaxyl (71626-11-4), (12.2) benalaxyl-M (kiralaxyl) (98243-83-5), (12.3) bupirimate (41483-43-6), (12.4) clozylacon (67932-85-8), (12.5) dimethirimol (5221-53-4), (12.6) ethirimol (23947-60-6), (12.7) furalaxyl (57646-30-7), (12.8) hymexazol (10004-44-1), (12.9) metalaxyl (57837-19-1), (12.10) metalaxyl-M (mefenoxam) (70630-17-0), (12.11) ofurace (58810-48-3), (12.12) oxadixyl (77732-09-3), (12.13) oxolinic acid (14698-29-4).

(13) Inhibitors of the signal transduction, for example (13.1) chlozolinate (84332-86-5), (13.2) fenpiclonil (74738-17-3), (13.3) fludioxonil (131341-86-1), (13.4) iprodione (36734-19-7), (13.5) procymidone (32809-16-8), (13.6) quinoxyfen (124495-18-7), (13.7) vinclozolin (50471-44-8).

(14) Compounds capable to act as an uncoupler, like for example (14.1) binapacryl (485-31-4), (14.2) dinocap (131-72-6), (14.3) ferimzone (89269-64-7), (14.4) fluazinam (79622-59-6), (14.5) meptyldinocap (131-72-6).

(15) Further compounds, like for example (15.1) benthiazole (21564-17-0), (15.2) bethoxazin (163269-30-5), (15.3) capsimycin (70694-08-5), (15.4) carvone (99-49-0), (15.5) chinomethionat (2439-01-2), (15.6) pyriofenone (chlazafenone) (688046-61-9), (15.7) cufraneb (11096-18-7), (15.8) cyflufenamid (180409-60-3), (15.9) cymoxanil (57966-95-7), (15.10) cyprosulfamide (221667-31-8), (15.11) dazomet (533-74-4), (15.12) debacarb (62732-91-6), (15.13) dichlorophen (97-23-4), (15.14) diclomezine (62865-36-5), (15.15) difenzoquat (49866-87-7), (15.16) difenzoquat methylsulphate (43222-48-6), (15.17) diphenylamine (122-39-4), (15.18) ecomate, (15.19) fenpyrazamine (473798-59-3), (15.20) flumetover (154025-04-4), (15.21) fluoroimide (41205-21-4), (15.22) flusulfamide (106917-52-6), (15.23) flutianil (304900-25-2), (15.24) fosetyl-aluminium (39148-24-8), (15.25) fosetyl-calcium, (15.26) fosetyl-sodium (39148-16-8), (15.27) hexachlorobenzene (118-74-1), (15.28) irumamycin (81604-73-1), (15.29) methasulfocarb (66952-49-6), (15.30) methyl isothiocyanate (556-61-6), (15.31) metrafenone (220899-03-6), (15.32) mildiomycin (67527-71-3), (15.33) natamycin (7681-93-8), (15.34) nickel dimethyldithiocarbamate (15521-65-0), (15.35) nitrothal-isopropyl (10552-74-6), (15.36) octhilinone (26530-20-1), (15.37) oxamocarb (917242-12-7), (15.38) oxyfenthiin (34407-87-9), (15.39) pentachlorophenol and salts (87-86-5), (15.40) phenothrin, (15.41) phosphorous acid and its salts (13598-36-2), (15.42) propamocarb-fosetylate, (15.43) propanosine-sodium (88498-02-6), (15.44) proquinazid (189278-12-4), (15.45) pyrimorph (868390-90-3), (15.45e) (2E)-3-(4-tert-butylphenyl)-3-(2-chloropyridin-4-yl)-1-(morpholin-4-yl)prop-2-en-1-one (1231776-28-5), (15.45z) (2Z)-3-(4-tert-butylphenyl)-3-(2-chloropyridin-4-yl)-1-(morpholin-4-yl)prop-2-en-1-one (1231776-29-6), (15.46) pyrroInitrine (1018-71-9), (15.47) tebufloquin (376645-78-2), (15.48) tecloftalam (76280-91-6), (15.49) tolnifanide (304911-98-6), (15.50) triazoxide (72459-58-6), (15.51) trichlamide (70193-21-4), (15.52) zarilamid (84527-51-5), (15.53) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate (517875-34-2), (15.54) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone (1003319-79-6), (15.55) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone (1003319-80-9), (15.56) 1-(4-{4-[5-(2,6-difluorophenyl)-4,5-dihydro-1,2-oxazol-3-yl]-1,1,3-thiazol-2-yl}piperidin-1-yl)-2-[5-methyl-3-(trifluoromethyl)-1H-pyrazol-1-yl]ethanone (1003318-67-9), (15.57) 1-(4-methoxyphenoxy)-3,3-dimethylbutan-2-yl 1H-imidazole-1-carboxylate (111227-17-9), (15.58) 2,3,5,6-tetrachloro-4-(methylsulfonyl)pyridine (13108-52-6), (15.59) 2,3-dibutyl-6-chlorothieno[2,3-d]pyrimidin-4(3H)-one (221451-58-7), (15.60) 2,6-dimethyl-1H,5H-[1,4]dithiino[2,3-c:5,6-c′]dipyrrole-1,3,5,7(2H,6H)-tetrone, (15.61) 2-[5-methyl-3-(trifluoromethyl)-1H-pyrazol-1-yl]-1-(4-{4-[(5R)-5-phenyl-4,5-dihydro-1,2-oxazol-3-yl]-1,3-thiazol-2-yl}piperidin-1-yl)ethanone (1003316-53-7), (15.62) 2-[5-methyl-3-(trifluoromethyl)-1H-pyrazol-1-yl]-1-(4-{4-[(5S)-5-phenyl-4,5-dihydro-1,2-oxazol-3-yl]-1,3-thiazol-2-yl}piperidin-1-yl)ethanone (1003316-54-8), (15.63) 2-[5-methyl-3-(trifluoromethyl)-1H-pyrazol-1-yl]-1-{4-[4-(5-phenyl-4,5-dihydro-1,2-oxazol-3-yl)-1,3-thiazol-2-yl]piperidin-1-yl}ethanone (1003316-51-5), (15.64) 2-butoxy-6-iodo-3-propyl-4H-chromen-4-one, (15.65) 2-chloro-5-[2-chloro-1-(2,6-difluoro-4-methoxyphenyl)-4-methyl-1H-imidazol-5-yl]pyridine, (15.66) 2-phenylphenol and salts (90-43-7), (15.67) 3-(4,4,5-trifluoro-3,3-dimethyl-3,4-dihydroisoquinolin-1-yl)quinoline (861647-85-0), (15.68) 3,4,5-trichloropyridine-2,6-dicarbonitrile (17824-85-0), (15.69) 3-[5-(4-chlorophenyl)-2,3-dimethyl-1,2-oxazolidin-3-yl]pyridine, (15.70) 3-chloro-5-(4-chlorophenyl)-4-(2,6-difluorophenyl)-6-methylpyridazine, (15.71) 4-(4-chlorophenyl)-5-(2,6-difluorophenyl)-3,6-dimethylpyridazine, (15.72) 5-amino-1,3,4-thiadiazole-2-thiol, (15.73) 5-chloro-N′-phenyl-N′-(prop-2-yn-1-yl)thiophene-2-sulfonohydrazide (134-31-6), (15.74) 5-fluoro-2-[(4-fluorobenzyl)oxy]pyrimidin-4-amine (1174376-11-4), (15.75) 5-fluoro-2-[(4-methylbenzyl)oxy]pyrimidin-4-amine (1174376-25-0), (15.76) 5-methyl-6-octyl[1,2,4]triazolo[1,5-a]pyrimidin-7-amine, (15.77) ethyl (2Z)-3-amino-2-cyano-3-phenylprop-2-enoate, (15.78) N′-(4-{[3-(4-chlorobenzyl)-1,2,4-thiadiazol-5-yl]oxy}-2,5-dimethylphenyl)-N-ethyl-N-methylimidoformamide, (15.79) N-(4-chlorobenzyl)-3-[3-methoxy-4-(prop-2-yn-1-yloxy)phenyl]propanamide, (15.80) N-[(4-chlorophenyl)(cyano)methyl]-3-[3-methoxy-4-(prop-2-yn-1-yloxy)phenyl]propanamide, (15.81) N-[(5-bromo-3-chloropyridin-2-yl)methyl]-2,4-dichloropyridine-3-carboxamide, (15.82) N-[1-(5-bromo-3-chloropyridin-2-yl)ethyl]-2,4-dichloropyridine-3-carboxamide, (15.83) N-[1-(5-bromo-3-chloropyridin-2-yl)ethyl]-2-fluoro-4-iodopyridine-3-carboxamide, (15.84) N-{(E)-[(cyclopropylmethoxy)imino][6-(difluoromethoxy)-2,3-difluorophenyl]methyl}-2-phenylacetamide (221201-92-9), (15.85) N-{(Z)-[(cyclopropylmethoxy)imino][6-(difluoromethoxy)-2,3-difluorophenyl]methyl}-2-phenylacetamide (221201-92-9), (15.86) N′-{4-[β-tert-butyl-4-cyano-1,2-thiazol-5-yl)oxy]-2-chloro-5-methylphenyl}-N-ethyl-N-methylimidoformamide, (15.87) N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide (922514-49-6), (15.88) N-methyl-2-(1-{[5-methyl-3-(trifluoromethyl)-1H-pyrazol-1-yl]acetyl}piperidin-4-yl)-N-[(1R)-1,2,3,4-tetrahydronaphthalen-1-yl]-1,3-thiazole-4-carboxamide (922514-07-6), (15.89) N-methyl-2-(1-{[5-methyl-3-(trifluoromethyl)-1H-pyrazol-1-yl]acetyl}piperidin-4-yl)-N-[(1S)-1,2,3,4-tetrahydronaphthalen-1-yl]-1,3-thiazole-4-carboxamide (922514-48-5), (15.90) pentyl {6-[({[(1-methyl-1H-tetrazol-5-yl)(phenyl)methylidene]amino}oxy)methyl]pyridin-2-yl}carbamate, (15.91) phenazine-1-carboxylic acid, (15.92) quinolin-8-ol (134-31-6), (15.93) quinolin-8-ol sulfate (2:1) (134-31-6), (15.94) tert-butyl {6-[({[(1-methyl-1H-tetrazol-5-yl)(phenyl)methylene]amino}oxy)methyl]pyridin-2-yl}carbamate.

(16) Further compounds, like for example (16.1) 1-methyl-3-(trifluoromethyl)-N-[2′-(trifluoromethyl)biphenyl-2-yl]-1H-pyrazole-4-carboxamide, (16.2) N-(4′-chlorobiphenyl-2-yl)-3-(difluoromethyl)-1-methyl-1H-pyrazole-4-carboxamide, (16.3) N-(2′,4′-dichlorobiphenyl-2-yl)-3-(difluoromethyl)-1-methyl-1H-pyrazole-4-carboxamide, (16.4) 3-(difluoromethyl)-1-methyl-N-[4′-(trifluoromethyl)biphenyl-2-yl]-1H-pyrazole-4-carboxamide, (16.5) N-(2′,5′-difluorobiphenyl-2-yl)-1-methyl-3-(trifluoromethyl)-1H-pyrazole-4-carboxamide, (16.6) 3-(difluoromethyl)-1-methyl-N-[4′-(prop-1-yn-1-yl)biphenyl-2-yl]-1H-pyrazole-4-carboxamide, (16.7) 5-fluoro-1,3-dimethyl-N-[4′-(prop-1-yn-1-yl)biphenyl-2-yl]-1H-pyrazole-4-carboxamide, (16.8) 2-chloro-N-[4′-(prop-1-yn-1-yl)biphenyl-2-yl]pyridine-3-carboxamide, (16.9) 3-(difluoromethyl)-N-[4′-(3,3-dimethylbut-1-yn-1-yl)biphenyl-2-yl]-1-methyl-1H-pyrazole-4-carboxamide, (16.10) N-[4′-(3,3-dimethylbut-1-yn-1-yl)biphenyl-2-yl]-5-fluoro-1,3-dimethyl-1H-pyrazole-4-carboxamide, (16.11) 3-(difluoromethyl)-N-(4′-ethynylbiphenyl-2-yl)-1-methyl-1H-pyrazole-4-carboxamide, (16.12) N-(4′-ethynylbiphenyl-2-yl)-5-fluoro-1,3-dimethyl-1H-pyrazole-4-carboxamide, (16.13) 2-chloro-N-(4′-ethynylbiphenyl-2-yl)pyridine-3-carboxamide, (16.14) 2-chloro-N-[4′-(3,3-dimethylbut-1-yn-1-yl)biphenyl-2-yl]pyridine-3-carboxamide, (16.15) 4-(difluoromethyl)-2-methyl-N-[4′-(trifluoromethyl)biphenyl-2-yl]-1,3-thiazole-5-carboxamide, (16.16) 5-fluoro-N-[4′-(3-hydroxy-3-methylbut-1-yn-1-yl)biphenyl-2-yl]-1,3-dimethyl-1H-pyrazole-4-carboxamide, (16.17) 2-chloro-N-[4′-(3-hydroxy-3-methylbut-1-yn-1-yl)biphenyl-2-yl]pyridine-3-carboxamide, (16.18) 3-(difluoromethyl)-N-[4′-(3-methoxy-3-methylbut-1-yn-1-yl)biphenyl-2-yl]-1-methyl-1H-pyrazole-4-carboxamide, (16.19) 5-fluoro-N-[4′-(3-methoxy-3-methylbut-1-yn-1-yl)biphenyl-2-yl]-1,3-dimethyl-1H-pyrazole-4-carboxamide, (16.20) 2-chloro-N-[4′-(3-methoxy-3-methylbut-1-yn-1-yl)biphenyl-2-yl]pyridine-3-carboxamide, (16.21) (5-bromo-2-methoxy-4-methylpyridin-3-yl)(2,3,4-trimethoxy-6-methylphenyl)methanone, (16.22) N-[2-(4-{[3-(4-chlorophenyl)prop-2-yn-1-yl]oxy}-3-methoxyphenyl)ethyl]-N2-(methylsulfonyl)valinamide (220706-93-4), (16.23) 4-oxo-4-[(2-phenylethyl)amino]butanoic acid, (16.24) but-3-yn-1-yl {6-[({[(Z)-(1-methyl-1H-tetrazol-5-yl)(phenyl)methylene]amino}oxy)methyl]pyridin-2-yl}carbamate, (16.25) 4-Amino-5-fluorpyrimidin-2-ol (mesomere Form: 6-Amino-5-fluorpyrimidin-2(1H)-on), (16.26) propyl 3,4,5-trihydroxybenzoate.

All named mixing partners of the classes (1) to (16) can, if their functional groups enable this, optionally form salts with suitable bases or acids.

The inventive method is preferably used with a fungicide selected in the list consisting of: penflufen, benalaxyl, ethirimol, hymexazol, mefenoxam, metalaxyl, metalaxyl-M, benomyl, carbendazim, fuberidazole, pencycuron, thiabendazole, zoxamide, boscalid, carboxin, flutolanil, furametpyr, penthiopyrad, thifluzamide, azoxystrobin, cyazofamid, dimoxystrobin, famoxadone, fenamidone, fluoxastrobin, metominostrobin, orysastrobin, picoxystrobin, pyraclostrobin, trifloxystrobin, fluazinam, silthiofam, cyprodinil, kasugamycin, mepanipyrim, pyrimethanil, fenpiclonil, fludioxonil, iprodione, procymidone, propamocarb, tolclofos-methyl, bitertanol, cyproconazole, difenoconazole, diniconazole, epoxiconazole, etaconazole, fenhexamid, fluquinconazole, flutriafol, hexaconazole, imazalil, imibenconazole, ipconazole, metconazole, prochloraz, prothioconazole, simeconazole, spiroxamine, tebuconazole, tetraconazole, triadimefon, triadimenol, triflumizole, triticonazole, carpropamid, tolylfluanid, fluopicolide, isotianil, N-{2-[1,1′-bi(cyclopropyl)-2-yl]phenyl}-3-(difluoromethyl)-, 1-methyl-1H-pyrazole-4-carboxamide, propamocarb fosetylate, triazoxide, N-(3′,4′-dichloro-5-fluorobiphenyl-2-yl)-3-(difluoromethyl)-1-methyl-1H-pyrazole-4-carboxamide, N-{2-[3-chloro-5-(trifluoromethyl)pyridin-2-yl]ethyl}-2-(trifluoromethyl)benzamide.

The inventive method is more preferably used with a fungicide selected in the list consisting of:

penflufen, metalaxyl, carbendazim, pencycuron, fenamidone, fluoxastrobin, trifloxystrobin, pyrimethanil, iprodione, bitertanol, fluquinconazole, ipconazole, prochloraz, prothioconazole, tebuconazole, triadimenol, triticonazole, carpropamid, tolylfluanid, fluopicolide, isotianil, N-{2-[1,1′-bi(cyclopropyl)-2-yl]phenyl}-3-(difluoromethyl)-, 1-methyl-1H-pyrazole-4-carboxamide, propamocarb fosetylate, N-(3′,4′-dichloro-5-fluorobiphenyl-2-yl)-3-(difluoromethyl)-1-methyl-1H-pyrazole-4-carboxamide, N-{2-[3-chloro-5-(trifluoromethyl)pyridin-2-yl]ethyl}-2-(trifluoromethyl)benzamide, fludioxonil, mefenoxam, pyraclostrobin, boscalid, azoxystrobin.

In a particular embodiment of the invention, the lipochito-oligosaccharide derivative (component (a)) is associated with a fungicide (component (b)) in a (a)/(b) weight ratio of from 1/1 to 1/10¹⁴.

In a particular embodiment, the inventive method can be used in particular with the following groups of insecticides, acaricides, and nematicides:

The active ingredients specified herein by their “common name” are known and described, for example, in the Pesticide Manual (“The Pesticide Manual”, 14th Ed., British Crop Protection Council 2006) or can be searched in the internet (e.g. http://www.alanwood.net/pesticides).

(1) Acetylcholinesterase (AChE) inhibitors, for example

carbamates, e.g. Alanycarb (II-1-1), Aldicarb (II-1-2), Bendiocarb (II-1-3), Benfuracarb (II-1-4), Butocarboxim (II-1-5), Butoxycarboxim (II-1-6), Carbaryl (II-1-7), Carbofuran (II-1-8), Carbosulfan (II-1-9), Ethiofencarb (II-1-10), Fenobucarb (II-1-11), Formetanate (II-1-12), Furathiocarb (II-1-13), Isoprocarb (II-1-14), Methiocarb (II-1-15), Methomyl (II-1-16), Metolcarb (II-1-17), Oxamyl (II-1-18), Pirimicarb (II-1-19), Propoxur (II-1-20), Thiodicarb (II-1-21), Thiofanox (II-1-22), Triazamate (II-1-23), Trimethacarb (II-1-24), XMC (II-1-25), and Xylylcarb (II-1-26); or
organophosphates, e.g. Acephate (II-1-27), Azamethiphos (II-1-28), Azinphos-ethyl (II-1-29), Azinphos-methyl (II-1-30), Cadusafos (II-1-31), Chlorethoxyfos (II-1-32), Chlorfenvinphos (II-1-33), Chlormephos (II-1-34), Chlorpyrifos (II-1-35), Chlorpyrifos-methyl (II-1-36), Coumaphos (II-1-37), Cyanophos (II-1-38), Demeton-5-methyl (II-1-39), Diazinon (II-1-40), Dichlorvos/DDVP (II-1-41), Dicrotophos (II-1-42), Dimethoate (II-1-43), Dimethylvinphos (II-1-44), Disulfoton (II-1-45), EPN (II-1-46), Ethion (II-1-47), Ethoprophos (II-1-48), Famphur (II-1-49), Fenamiphos (II-1-50), Fenitrothion (II-1-51), Fenthion (II-1-52), Fosthiazate (II-1-53), Heptenophos (II-1-54), Imicyafos (II-1-55), Isofenphos (II-1-56), Isopropyl O-(methoxyaminothio-phosphoryl) salicylate (II-1-57), Isoxathion (II-1-58), Malathion (II-1-59), Mecarbam (II-1-60), Methamidophos (II-1-61), Methidathion (II-1-62), Mevinphos (II-1-63), Monocrotophos (II-1-64), Naled (II-1-65), Omethoate (II-1-66), Oxydemeton-methyl (II-1-67), Parathion (II-1-68), Parathion-methyl (II-1-69), Phenthoate (II-1-70), Phorate (II-1-71), Phosalone (II-1-72), Phosmet (II-1-73), Phosphamidon (II-1-74), Phoxim (II-1-75), Pirimiphos-methyl (II-1-76), Profenofos (II-1-77), Propetamphos (II-1-78), Prothiofos (II-1-79), Pyraclofos (II-1-80), Pyridaphenthion (II-1-81), Quinalphos (II-1-82), Sulfotep (II-1-83), Tebupirimfos (II-1-84), Temephos (II-1-85), Terbufos (II-1-86), Tetrachlorvinphos (II-1-87), Thiometon (II-1-88), Triazophos (II-1-89), Trichlorfon (II-1-90), and Vamidothion (II-1-91).

(2) GABA-gated chloride channel antagonists, for example

cyclodiene organochlorines, e.g. Chlordane (II-2-1) and Endosulfan (II-2-2); or
phenylpyrazoles (fiproles), e.g. Ethiprole (II-2-3) and Fipronil (II-2-4).

(3) Sodium channel modulators/voltage-dependent sodium channel blockers, for example

pyrethroids, e.g. Acrinathrin (II-3-1), Allethrin (II-3-2), d-cis-trans Allethrin (II-3-3), d-trans Allethrin (II-3-4), Bifenthrin (II-3-5), Bioallethrin (II-3-6), Bioallethrin S-cyclopentenyl isomer (II-3-7), Bioresmethrin (II-3-8), Cycloprothrin (II-3-9), Cyfluthrin (II-3-10), beta-Cyfluthrin (II-3-11), Cyhalothrin (II-3-12), lambda-Cyhalothrin (II-3-13), gamma-Cyhalothrin (II-3-14), Cypermethrin (II-3-15), alpha-Cypermethrin (II-3-16), beta-Cypermethrin (II-3-17), theta-Cypermethrin (II-3-18), zeta-Cypermethrin (II-3-19), Cyphenothrin [(1R)-trans isomers] (II-3-20), Deltamethrin (II-3-21), Empenthrin [(EZ)-(1R) isomers) (II-3-22), Esfenvalerate (II-3-23), Etofenprox (II-3-24), Fenpropathrin (II-3-25), Fenvalerate (II-3-26), Flucythrinate (II-3-27), Flumethrin (II-3-28), tau-Fluvalinate (II-3-29), Halfenprox (II-3-30), Imiprothrin (II-3-31), Kadethrin (II-3-32), Permethrin (II-3-33), Phenothrin [(1R)-trans isomer)] (II-3-34), Prallethrin (II-3-35), Pyrethrine (pyrethrum) (II-3-36), Resmethrin (II-3-37), Silafluofen (II-3-38), Tefluthrin (II-3-39), Tetramethrin (II-3-40), Tetramethrin [(1R) isomers)](II-3-41), Tralomethrin (II-3-42), and Transfluthrin (II-3-43); or

DDT (II-3-44); or Methoxychlor (II-3-45).

(4) Nicotinic acetylcholine receptor (nAChR) agonists, for example

neonicotinoids, e.g. Acetamiprid (II-4-1), Clothianidin (II-4-2), Dinotefuran (II-4-3), Imidacloprid (II-4-4), Nitenpyram (II-4-5), Thiacloprid (II-4-6), and Thiamethoxam (II-4-7); or

Nicotine (II-4-8).

(5) Nicotinic acetylcholine receptor (nAChR) allosteric activators, for example

spinosyns, e.g. Spinetoram (II-5-1) and Spinosad (II-5-2).

(6) Chloride channel activators, for example

avermectins/milbemycins, e.g. Abamectin (II-6-1), Emamectin benzoate (II-6-2), Lepimectin (II-6-3), and Milbemectin (II-6-4).

(7) Juvenile hormone mimics, for example

juvenile hormon analogues, e.g. Hydroprene (II-7-1), Kinoprene (II-7-2), and Methoprene (II-7-3); or

Fenoxycarb (II-7-4); or Pyriproxyfen (II-7-5).

(8) Miscellaneous non-specific (multi-site) inhibitors, for example

alkyl halides, e.g. Methyl bromide (II-8-1) and other alkyl halides; or

Chloropicrin (II-8-2); or Sulfuryl fluoride (II-8-3); or Borax (II-8-4); or Tartar emetic (II-8-5).

(9) Selective homopteran feeding blockers, e.g. Pymetrozine (II-9-1); or Flonicamid (II-9-2).

(10) Mite growth inhibitors, e.g. Clofentezine (II-10-1), Hexythiazox (II-10-2), and Diflovidazin (II-10-3); or

Etoxazole (II-10-4).

(11) Microbial disruptors of insect midgut membranes, e.g. Bacillus thuringiensis subspecies israelensis (II-11-1), Bacillus sphaericus (II-11-2), Bacillus thuringiensis subspecies aizawai (II-11-3), Bacillus thuringiensis subspecies kurstaki (II-11-4), Bacillus thuringiensis subspecies tenebrionis (II-11-5), and BT crop proteins: Cry1Ab, Cry1Ac, Cry1Fa, Cry2Ab, mCry3A, Cry3Ab, Cry3Bb, Cry34/35Ab1 (II-11-6).

(12) Inhibitors of mitochondrial ATP synthase, for example Diafenthiuron (II-12-1); or

organotin miticides, e.g. Azocyclotin (II-12-2), Cyhexatin (II-12-3), and Fenbutatin oxide (II-12-4); or

Propargite (II-12-5); or Tetradifon (II-12-6).

(13) Uncouplers of oxidative phoshorylation via disruption of the proton gradient, for example Chlorfenapyr (II-13-1), DNOC (II-13-2), and Sulfluramid (II-13-3).

(14) Nicotinic acetylcholine receptor (nAChR) channel blockers, for example Bensultap (II-14-1), Cartap hydrochloride (II-14-2), Thiocyclam (II-14-3), and Thiosultap-sodium (II-14-4).

(15) Inhibitors of chitin biosynthesis, type 0, for example Bistrifluoron (II-15-1), Chlorfluazuron (II-15-2), Diflubenzuron (II-15-3), Flucycloxuron (II-15-4), Flufenoxuron (II-15-5), Hexaflumuron (II-15-6), Lufenuron (II-15-7), Novaluron (II-15-8), Noviflumuron (II-15-9), Teflubenzuron (II-15-10), and Triflumuron (II-15-11).

(16) Inhibitors of chitin biosynthesis, type 1, for example Buprofezin (II-16-1).

(17) Moulting disruptors, for example Cyromazine (II-17-1).

(18) Ecdysone receptor agonists, for example Chromafenozide (II-18-1), Halofenozide (II-18-2), Methoxyfenozide (II-18-3), and Tebufenozide (II-18-4).

(19) Octopamine receptor agonists, for example Amitraz (II-19-1).

(20) Mitochondrial complex III electron transport inhibitors, for example Hydramethylnon (II-20-1); or Acequinocyl (II-20-2); or Fluacrypyrim (II-20-3).

(21) Mitochondrial complex I electron transport inhibitors, for example

METI acaricides, e.g. Fenazaquin (II-21-1), Fenpyroximate (II-21-2), Pyrimidifen (II-21-3), Pyridaben (II-21-4), Tebufenpyrad (II-21-5), and Tolfenpyrad (II-21-6); or

Rotenone (Derris) (II-21-7).

(22) Voltage-dependent sodium channel blockers, e.g. Indoxacarb (II-22-1); or Metaflumizone (II-22-2).

(23) Inhibitors of acetyl CoA carboxylase, for example

tetronic and tetramic acid derivatives, e.g. Spirodiclofen (II-23-1), Spiromesifen (II-23-2), and Spirotetramat (II-23-3).

(24) Mitochondrial complex IV electron transport inhibitors, for example

phosphines, e.g. Aluminium phosphide (II-24-1), Calcium phosphide (II-24-2), Phosphine (II-24-3), and Zinc phosphide (II-24-4); or

Cyanide (II-24-5).

(25) Mitochondrial complex II electron transport inhibitors, for example Cyenopyrafen (II-25-1).

(28) Ryanodine receptor modulators, for example

diamides, e.g. Chlorantraniliprole (II-28-1) and Flubendiamide (II-28-2).

Further active ingredients with unknown or uncertain mode of action, for example Amidoflumet (II-29-1), Azadirachtin (II-29-2), Benclothiaz (II-29-3), Benzoximate (II-29-4), Bifenazate (II-29-5), Bromopropylate (II-29-6), Chinomethionat (II-29-7), Cryolite (II-29-8), Cyantraniliprole (Cyazypyr) (II-29-9), Cyflumetofen (II-29-10), Dicofol (II-29-11), Diflovidazin (II-29-12), Fluensulfone (II-29-13), Flufenerim (II-29-14), Flufiprole (II-29-15), Fluopyram (II-29-16), Fufenozide (II-29-17), Imidaclothiz (II-29-18), Iprodione (II-29-19), Meperfluthrin (II-29-20), Pyridalyl (II-29-21), Pyrifluquinazon (II-29-22), Tetramethylfluthrin (II-29-23), and iodomethane (II-29-24); furthermore products based on Bacillus firmus (including but not limited to strain CNCM I-1582, such as, for example, VOTiVO™, BioNem) (II-29-25) or one of the following known active compounds: 3-bromo-N-{2-bromo-4-chloro-6-[(1-cyclopropylethyl)carbamoyl]phenyl}-1-(3-chloropyridin-2-yl)-1H-pyrazole-5-carboxamide (II-29-26) (known from WO2005/077934), 4-{[(6-bromopyridin-3-yl)methyl](2-fluoroethyl)amino}furan-2(5H)-one (II-29-27) (known from WO2007/115644), 4-{[(6-fluoropyridin-3-yl)methyl](2,2-difluoroethyl)amino}furan-2(5H)-one (II-29-28) (known from WO2007/115644), 4-{[(2-chloro-1,3-thiazol-5-yl)methyl](2-fluoroethyl)amino}furan-2(5H)-one (II-29-29) (known from WO2007/115644), 4-{[(6-chlorpyridin-3-yl)methyl](2-fluoroethyl)amino}furan-2(5H)-one (II-29-30) (known from WO2007/115644), Flupyradifurone (II-29-31), 4-{[(6-chlor-5-fluoropyridin-3-yl)methyl](methyl)amino}furan-2(5H)-one (II-29-32) (known from WO2007/115643), 4-{[(5,6-dichloropyridin-3-yl)methyl](2-fluoroethyl)amino}furan-2(5H)-one (II-29-33) (known from WO2007/115646), 4-{[(6-chloro-5-fluoropyridin-3-yl)methyl](cyclopropyl)amino}furan-2(5H)-one (II-29-34) (known from WO2007/115643), 4-{[(6-chloropyridin-3-yl)methyl](cyclopropyl)amino}furan-2(5H)-one (II-29-35) (known from EP-A-0 539 588), 4-{[(6-chlorpyridin-3-yl)methyl](methyl)amino}furan-2(5H)-one (II-29-36) (known from EP-A-0 539 588), {[1-(6-chloropyridin-3-yl)ethyl](methyl)oxido-λ⁴-sulfanylidene}cyanamide (II-29-37) (known from WO2007/149134) and its diastereomers {[(1R)-1-(6-chloropyridin-3-yl)ethyl](methyl)oxido-λ⁴-sulfanylidene}cyanamide (A) (II-29-38), and {[(1S)-1-(6-chloropyridin-3-yl)ethyl](methyl)oxido-λ⁴-sulfanylidene}cyanamide (B) (II-29-39) (also known from WO2007/149134) as well as Sulfoxaflor (II-29-40) and its diastereomers [(R)-methyl(oxido){(1R)-1-[6-(trifluoromethyl)pyridin-3-yl]ethyl}-λ⁴-sulfanylidene]cyanamide (A1) (II-29-41), and [(S)-methyl(oxido) {(1S)-[6-(trifluoromethyl)pyridin-3-yl]ethyl}-λ⁴-sulfanylidene]cyanamide (A2) (II-29-42), referred to as group of diastereomers A (known from WO2010/074747, WO2010/074751), [(R)-methyl(oxido) {(1S)-1-[6-(trifluoromethyl)pyridin-3-yl]ethyl}-λ⁴-sulfanylidene]cyanamide (B1) (II-29-43), and [(S)-methyl(oxido){(1R)-1-[6-(trifluoromethyl)pyridin-3-yl]ethyl}-λ⁴-sulfanylidene]cyanamide (B2) (II-29-44), referred to as group of diastereomers B (also known from WO2010/074747, WO2010/074751), and 11-(4-chloro-2,6-dimethylphenyl)-12-hydroxy-1,4-dioxa-9-azadispiro[4.2.4.2]tetradec-11-en-10-one (II-29-45) (known from WO2006/089633), 3-(4′-fluoro-2,4-dimethylbiphenyl-3-yl)-4-hydroxy-8-oxa-1-azaspiro[4.5]dec-3-en-2-one (II-29-46) (known from WO2008/067911), 1-{2-fluoro-4-methyl-5-[(2,2,2-trifluorethyl)sulfinyl]phenyl}-3-(trifluoromethyl)-1H-1,2,4-triazol-5-amine (II-29-47) (known from WO2006/043635), [(3S,4aR,12R,12aS,12bS)-3-[(cyclopropylcarbonyl)oxy]-6,12-dihydroxy-4,12b-dimethyl-11-oxo-9-(pyridin-3-yl)-1,3,4,4a,5,6,6a,12,12a, 12b-decahydro-2H, 11H-benzo[f]pyrano[4,3-b]chromen-4-yl]methyl cyclopropanecarboxylate (II-29-48) (known from WO2008/066153), 2-cyano-3-(difluoromethoxy)-N,N-dimethylbenzenesulfonamide (II-29-49) (known from WO2006/056433), 2-cyano-3-(difluoromethoxy)-N-methylbenzenesulfonamide (II-29-50) (known from WO2006/100288), 2-cyano-3-(difluoromethoxy)-N-ethylbenzenesulfonamide (II-29-51) (known from WO2005/035486), 4-(difluoromethoxy)-N-ethyl-N-methyl-1,2-benzothiazol-3-amine 1,1-dioxide (II-29-52) (known from WO2007/057407), N-[1-(2,3-dimethylphenyl)-2-(3,5-dimethylphenyl)ethyl]-4,5-dihydro-1,3-thiazol-2-amine (II-29-53) (known from WO2008/104503), {1′-[(2E)-3-(4-chlorophenyl)prop-2-en-1-yl]-5-fluorospiro[indole-3,4′-piperidin]-1(2H)-yl}(2-chloropyridin-4-yl)methanone (II-29-54) (known from WO2003/106457), 3-(2,5-dimethylphenyl)-4-hydroxy-8-methoxy-1,8-diazaspiro[4.5]dec-3-en-2-one (II-29-55) (known from WO2009/049851), 3-(2,5-dimethylphenyl)-8-methoxy-2-oxo-1,8-diazaspiro[4.5]dec-3-en-4-yl ethyl carbonate (II-29-56) (known from WO2009/049851), 4-(but-2-yn-1-yloxy)-6-(3,5-dimethylpiperidin-1-yl)-5-fluoropyrimidine (II-29-57) (known from WO2004/099160), (2,2,3,3,4,4,5,5-octafluoropentyl)(3,3,3-trifluoropropyl)malononitrile (II-29-58) (known from WO2005/063094), (2,2,3,3,4,4,5,5-octafluoropentyl)(3,3,4,4,4-pentafluorobutyl)malononitrile (II-29-59) (known from WO2005/063094), 8-[2-(cyclopropylmethoxy)-4-(trifluoromethyl)phenoxy]-3-[6-(trifluoromethyl)pyridazin-3-yl]-3-azabicyclo[3.2.1]octane (II-29-60) (known from WO2007/040280), Flometoquin (II-29-61), PF1364 (CAS-Reg. No. 1204776-60-2) (II-29-62) (known from JP2010/018586), 5-[5-(3,5-dichlorophenyl)-5-(trifluoromethyl)-4,5-dihydro-1,2-oxazol-3-yl]-2-(1H-1,2,4-triazol-1-yl)benzonitrile (II-29-63) (known from WO2007/075459), 5-[5-(2-chloropyridin-4-yl)-5-(trifluoromethyl)-4,5-dihydro-1,2-oxazol-3-yl]-2-(1H-1,2,4-triazol-1-yl)benzonitrile (II-29-64) (known from WO2007/075459), 4-[5-(3,5-dichlorophenyl)-5-(trifluoromethyl)-4,5-dihydro-1,2-oxazol-3-yl]-2-methyl-N-{2-oxo-2-[(2,2,2-trifluoroethyl)amino]ethyl}benzamide (II-29-65) (known from WO2005/085216), 4-{[(6-chloropyridin-3-yl)methyl](cyclopropyl)amino}-1,3-oxazol-2(5H)-one (II-29-66), 4-{[(6-chloropyridin-3-yl)methyl](2,2-difluoroethyl)amino}-1,3-oxazol-2(5H)-one (II-29-67), 4-{[(6-chloropyridin-3-yl)methyl](ethyl)amino}-1,3-oxazol-2(5H)-one (II-29-68), 4-{[(6-chloropyridin-3-yl)methyl](methyl)amino}-1,3-oxazol-2(5H)-one (II-29-69) (all known from WO2010/005692), NNI-0711 (II-29-70) (known from WO2002/096882), 1-acetyl-N-[4-(1,1,1,3,3,3-hexafluoro-2-methoxypropan-2-yl)-3-isobutylphenyl]-N-isobutyryl-3,5-dimethyl-1H-pyrazole-4-carboxamide (II-29-71) (known from WO2002/096882), methyl 2-[2-({[3-bromo-1-(3-chloropyridin-2-yl)-1H-pyrazol-5-yl]carbonyl}amino)-5-chloro-3-methylbenzoyl]-2-methylhydrazinecarboxylate (II-29-72) (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-ethylhydrazinecarboxylate (II-29-73) (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-methylhydrazinecarboxylate (II-29-74) (known from WO2005/085216), methyl 2-[3,5-d]bromo-2-({[3-bromo-1-(3-chloropyridin-2-yl)-1H-pyrazol-5-yl]carbonyl}amino)benzoyl]-1,2-diethylhydrazinecarboxylate (II-29-75) (known from WO2005/085216), methyl 2-[3,5-d]bromo-2-({[3-bromo-1-(3-chloropyridin-2-yl)-1H-pyrazol-5-yl]carbonyl}amino)benzoyl]-2-ethylhydrazinecarboxylate (II-29-76) (known from WO2005/085216), (5RS,7RS;5RS,7SR)-1-(6-chloro-3-pyridylmethyl)-1,2,3,5,6,7-hexahydro-7-methyl-8-nitro-5-propoxyimidazo[1,2-a]pyridine (II-29-77) (known from WO2007/101369), 2-{6-[2-(5-fluoropyridin-3-yl)-1,3-thiazol-5-yl]pyridin-2-yl}pyrimidine (II-29-78) (known from WO2010/006713), 2-{6-[2-(pyridin-3-yl)-1,3-thiazol-5-yl]pyridin-2-yl}pyrimidine (II-29-79) (known from WO2010/006713), 1-(3-chloropyridin-2-yl)-N-[4-cyano-2-methyl-6-(methylcarbamoyl)phenyl]-3-{[5-(trifluoromethyl)-1H-tetrazol-1-yl]methyl}-1H-pyrazole-5-carboxamide (II-29-80) (known from WO2010/069502), 1-(3-chloropyridin-2-yl)-N-[4-cyano-2-methyl-6-(methylcarbamoyl)phenyl]-3-{[5-(trifluoromethyl)-2H-tetrazol-2-yl]methyl}-1H-pyrazole-5-carboxamide (II-29-81) (known from WO2010/069502), N-[2-(tert-butylcarbamoyl)-4-cyano-6-methylphenyl]-1-(3-chloropyridin-2-yl)-3-{[5-(trifluoromethyl)-1H-tetrazol-1-yl]methyl}-1H-pyrazole-5-carboxamide (II-29-82) (known from WO2010/069502), N-[2-(tert-butylcarbamoyl)-4-cyano-6-methylphenyl]-1-(3-chloropyridin-2-yl)-3-{[5-(trifluoromethyl)-2H-tetrazol-2-yl]methyl}-1H-pyrazole-5-carboxamide (II-29-83) (known from WO2010/069502), (1E)-N-[(6-chloropyridin-3-yl)methyl]-N′-cyano-N-(2,2-difluoroethyl)ethanimidamide (II-29-84) (known from WO2008/009360), N-[2-(5-amino-1,3,4-thiadiazol-2-yl)-4-chloro-6-methylphenyl]-3-bromo-1-(3-chloropyridin-2-yl)-1H-pyrazole-5-carboxamide (II-29-85) (known from CN102057925), and methyl 2-[3,5-d]bromo-2-({[3-bromo-1-(3-chloropyridin-2-yl)-1H-pyrazol-5-yl]carbonyl}amino)benzoyl]-2-ethyl-1-methylhydrazinecarboxylate (II-29-86) (known from WO2011/049233).

Preferably, The inventive method can be used with the following groups of insecticides, acaricides, and nematicides:
(1.1.1) clothianidin, (1.1.2) imidacloprid, (1.1.3) thiacloprid, (1.1.4) thiamethoxam, (1.1.5) acetamiprid,
(2.1.1) methiocarb, (2.1.2) thiodicarb, (2.1.3) aldicarb, (2.2.1)ethoprophos, (2.2.2) fenamiphos,
(3.1.1) beta-cyfluthrin, (3.1.2) cyfluthrin, (3.1.3) deltamethrin, (3.1.4) tefluthrin (3.2.1) indoxacarb,
(4.1.1) spinosad, (4.1.2) spinetoram also known as XDE-175, which is the compound known from WO 97/00265 A1, U.S. Pat. No. 6,001,981 and Pest Manag. Sci. 57, 177-185, 2001, it has the formula (I):

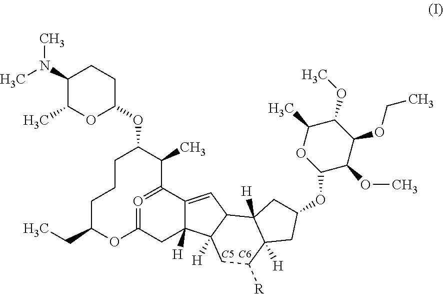

(5.2.1) fipronil, (5.2.2) ethiprole,
(6.1.1) emamectin-benzoate, (6.1.2) avermectin,
(7.1.1) pyriproxifen,
(8.1.1) methoxyfenozide,
(9.1.1) triflumuron, (9.1.2) flufenoxuron,
(10.1) diafenthiuron; (10.2) organotins (e.g. azocyclotin, cyhexatin, fenbutatin-oxide).
(11.1) pyrrole (e.g. chlorfenapyr); (11.2) dinitrophenole (e.g. binapacyrl, dinobuton, dinocap, DNOC).
(12.1.1) tebufenpyrad, (12.2.1) hydramethylnone,
(13.1) rotenone,
(14.1) acequinocyl, fluacrypyrim,
(15.1) Bacillus thuringiensis-strains,
(16.1.1) spirodiclofen, (16.1.2) spiromesifen, (16.2.1) spirotetramat,
(17.1) flonicamid,
(18.1) amitraz,
(19.1) propargite,
(20.1) N²-[1,1-dimethyl-2-(methylsulfonyl)ethyl]-3-iodo-N¹-[2-methyl-4-[1,2,2,2-tetrafluor-1-(trifluormethyl)ethyl]phenyl]-1,2-benzenedicarboxamide (flubendiamide, CAS-Reg.-No.: 272451-65-7), (20.2) rynaxypyr of the formula (II), (20.3) cyazypyr of the formula (III)

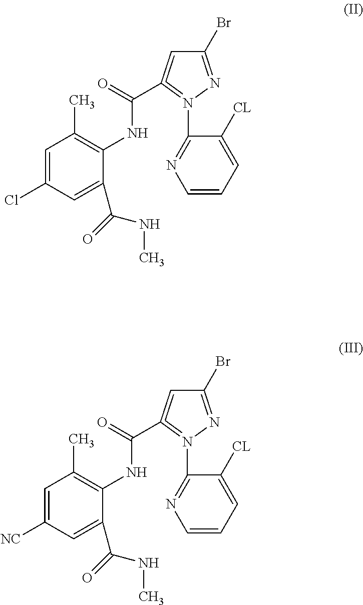

(21.1) thiocyclam hydrogen oxalate, thiosultap-sodium,
(22.1) azadirachtin, Bacillus spec., Beauveria spec., codlemone, Metarrhizium spec., Paecilomyces spec., thuringiensin, Verticillium spec.,
(23.1) fumigants (e.g. aluminium phosphide, methyl bromide, sulfuryl fluoride); (23.2) elective inhibitors of insect feeding (e.g. cryolite, flonicamid, pymetrozine); (23.3) inhibitors of mite growth (e.g. clofentezine, etoxazole, hexythiazox); (23.4) amidoflumet, benclothiaz, benz-oximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenz-imine, flufenerim, flutenzin, gossyplure, hydramethylnone, japonilure, metoxadiazone, petroleum, piperonyl butoxide, potassium oleate, pyrafluprole, pyridalyl, pyriprole, sulfluramid, tetradifon, tetrasul, triarathene, verbutin, 3-methyl-phenyl-propylcarbamat (tsumacide z), 3-(5-chlor-3-pyridinyl)-7-(2,2,2-trifluorethyl)-7-azabicyclo [3.2.1]octan-3-carbonitril (cas-reg.-nr. 175972-70-3) and the corresponding 3-endo-isomer (cas-reg.-nr. 175974-60-5) (compare WO 96/37494, WO 97/25923),

Very particularly preferred active ingredients are:

(1.1.1) clothianidin, (1.1.2) imidacloprid, (1.1.3) thiacloprid, (1.1.4) thiamethoxam, (1.1.5) acetamiprid, (2.1.1) methiocarb, (2.1.2) thiodicarb, (3.1.1) beta-cyfluthrin, (3.1.2) cyfluthrin, (3.1.3) deltamethrin, (3.1.4) tefluthrin, (3.2.1) indoxacarb, (4.1.1) spinosad, (4.1.2) spinetoram, (5.2.1) fipronil, (5.2.2) ethiprole, (6.1.1) emamectin-benzoate, (6.1.2) avermectin, (16.1.1) spirodiclofen, (16.1.2)spiromesifen, (16.2.1) spirotetramat, (20.1) flubendiamide, (20.2) rynaxypyr, (20.3) cyazypyr.

Most particularly preferred active ingredients are:
(1.1.1) clothianidin, (1.1.2) imidacloprid, (1.1.4) Thiacloprid, (II-4-6) thiamethoxam, (2.1.1) methiocarb, (2.1.2) thiodicarb, (3.1.1) beta-cyfluthrin, (3.1.4) tefluthrin, (4.1.1) spinosad,
(4.1.2) spinetoram, (5.2.1) fipronil, (5.2.2) ethiprole, (6.1.1) emamectin-benzoate, (6.1.2) avermectin, (16.2.1) spirotetramat, (20.2) rynaxypyr, (20.3) cyazypyr.

Other particularly preferred active ingredients are nicotinic acetylcholine reception agonists, for example neonicotinoids, e.g. Acetamiprid (II-4-1), Clothianidin (II-4-2), Dinotefuran (II-4-3), Imidacloprid (II-4-4), Nitenpyram (II-4-5), Thiacloprid (II-4-6), and Thiamethoxam (II-4-7); or Nicotine (II-4-8).

In a particular embodiment of the invention, the lipochito-oligosaccharide derivative (component (a)) is associated with an insecticide, acaricide or nematicide (component (c)) in a (a)/(c) weight ratio of from 1/1 to 1/10¹³

The method of treatment according to the invention can be used in the seed treatment of genetically modified organisms (GMOs), e.g. plants or seeds. Genetically modified plants (or transgenic plants) are plants of which a heterologous gene has been stably integrated into genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example, antisense technology, cosuppression technology or RNA interference—RNAi—technology). A heterologous gene that is located in the genome is also called a transgene. A transgene that is defined by its particular location in the plant genome is called a transformation or transgenic event.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the active compounds and compositions which can be used according to the invention, better plant growth, increased tolerance to high or low temperatures, increased tolerance to drought or to water or soil salt content, increased flowering performance, easier harvesting, accelerated maturation, higher harvest yields, bigger fruits, larger plant height, greener leaf color, earlier flowering, higher quality and/or a higher nutritional value of the harvested products, higher sugar concentration within the fruits, better storage stability and/or processability of the harvested products are possible, which exceed the effects which were actually to be expected.

At certain application rates, the active compound combinations according to the invention may also have a strengthening effect in plants. Accordingly, they are also suitable for mobilizing the defense system of the plant against attack by unwanted microorganisms. This may, if appropriate, be one of the reasons of the enhanced activity of the combinations according to the invention, for example against fungi. Plant-strengthening (resistance-inducing) substances are to be understood as meaning, in the present context, those substances or combinations of substances which are capable of stimulating the defense system of plants in such a way that, when subsequently inoculated with unwanted microorganisms, the treated plants display a substantial degree of resistance to these microorganisms. In the present case, unwanted microorganisms are to be understood as meaning phytopathogenic fungi, bacteria and viruses. Thus, the substances according to the invention can be employed for protecting plants against attack by the abovementioned pathogens within a certain period of time after the treatment. The period of time within which protection is effected generally extends from 1 to 10 days, preferably 1 to 7 days, after the treatment of the plants with the active compounds.

Plants and plant cultivars which are preferably to be treated according to the invention include all plants which have genetic material which impart particularly advantageous, useful traits to these plants (whether obtained by breeding and/or biotechnological means).

Plants and plant cultivars which are also preferably to be treated according to the invention are resistant against one or more biotic stresses, i.e. said plants show a better defense against animal and microbial pests, such as against nematodes, insects, mites, phytopathogenic fungi, bacteria, viruses and/or viroids.

Examples of nematode resistant plants are described in e.g. U.S. patent application Ser. Nos. 11/765,491, 11/765,494, 10/926,819, 10/782,020, 12/032,479, 10/783,417, 10/782,096, 11/657,964, 12/192,904, 11/396,808, 12/166,253, 12/166,239, 12/166,124, 12/166,209, 11/762,886, 12/364,335, 11/763,947, 12/252,453, 12/209,354, 12/491,396 or 12/497,221.

Plants and plant cultivars which may also be treated according to the invention are those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients, shade avoidance.

Plants and plant cultivars which may also be treated according to the invention, are those plants characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability.

Plants that may be treated according to the invention are hybrid plants that already express the characteristic of heterosis or hybrid vigor which results in generally higher yield, vigor, health and resistance towards biotic and abiotic stresses). Such plants are typically made by crossing an inbred male-sterile parent line (the female parent) with another inbred male-fertile parent line (the male parent). Hybrid seed is typically harvested from the male sterile plants and sold to growers. Male sterile plants can sometimes (e.g. in corn) be produced by detasseling, i.e. the mechanical removal of the male reproductive organs (or males flowers) but, more typically, male sterility is the result of genetic determinants in the plant genome. In that case, and especially when seed is the desired product to be harvested from the hybrid plants it is typically useful to ensure that male fertility in the hybrid plants is fully restored. This can be accomplished by ensuring that the male parents have appropriate fertility restorer genes which are capable of restoring the male fertility in hybrid plants that contain the genetic determinants responsible for male-sterility. Genetic determinants for male sterility may be located in the cytoplasm. Examples of cytoplasmic male sterility (CMS) were for instance described in Brassica species (WO 92/05251, WO 95/09910, WO 98/27806, WO 05/002324, WO 06/021972 and U.S. Pat. No. 6,229,072). However, genetic determinants for male sterility can also be located in the nuclear genome. Male sterile plants can also be obtained by plant biotechnology methods such as genetic engineering. A particularly useful means of obtaining male-sterile plants is described in WO 89/10396 in which, for example, a ribonuclease such as barnase is selectively expressed in the tapetum cells in the stamens. Fertility can then be restored by expression in the tapetum cells of a ribonuclease inhibitor such as barstar (e.g. WO 91/02069).

Plants or plant cultivars (obtained by plant biotechnology methods such as genetic engineering) which may be treated according to the invention are herbicide-tolerant plants, i.e. plants made tolerant to one or more given herbicides. Such plants can be obtained either by genetic transformation, or by selection of plants containing a mutation imparting such herbicide tolerance. Herbicide-resistant plants are for example glyphosate-tolerant plants, i.e. plants made tolerant to the herbicide glyphosate or salts thereof. Plants can be made tolerant to glyphosate through different means. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium (Comai et al., 1983, Science 221, 370-371), the CP4 gene of the bacterium Agrobacterium sp. (Barry et al., 1992, Curr. Topics Plant Physiol. 7, 139-145), the genes encoding a Petunia EPSPS (Shah et al., 1986, Science 233, 478-481), a Tomato EPSPS (Gasser et al., 1988, J. Biol. Chem. 263, 4280-4289), or an Eleusine EPSPS (WO 01/66704). It can also be a mutated EPSPS as described in for example EP 0837944, WO 00/66746, WO 00/66747 or WO02/26995. Glyphosate-tolerant plants can also be obtained by expressing a gene that encodes a glyphosate oxido-reductase enzyme as described in U.S. Pat. Nos. 5,776,760 and 5,463,175. Glyphosate-tolerant plants can also be obtained by expressing a gene that encodes a glyphosate acetyl transferase enzyme as described in for example WO 02/36782, WO 03/092360, WO 05/012515 and WO 07/024,782. Glyphosate-tolerant plants can also be obtained by selecting plants containing naturally-occurring mutations of the above-mentioned genes, as described in for example WO 01/024615 or WO 03/013226. Plants expressing EPSPS genes that confer glyphosate tolerance are described in e.g. U.S. patent application Ser. Nos. 11/517,991, 10/739,610, 12/139,408, 12/352,532, 11/312,866, 11/315,678, 12/421,292, 11/400,598, 11/651,752, 11/681,285, 11/605,824, 12/468,205, 11/760,570, 11/762,526, 11/769,327, 11/769,255, 11/943,801 or 12/362,774. Plants comprising other genes that confer glyphosate tolerance, such as decarboxylase genes, are described in e.g. U.S. patent application Ser. Nos. 11/588,811, 11/185,342, 12/364,724, 11/185,560 or 12/423,926.

Other herbicide resistant plants are for example plants that are made tolerant to herbicides inhibiting the enzyme glutamine synthase, such as bialaphos, phosphinothricin or glufosinate. Such plants can be obtained by expressing an enzyme detoxifying the herbicide or a mutant glutamine synthase enzyme that is resistant to inhibition, e.g. described in U.S. patent application Ser. No. 11/760,602. One such efficient detoxifying enzyme is an enzyme encoding a phosphinothricin acetyltransferase (such as the bar or pat protein from Streptomyces species). Plants expressing an exogenous phosphinothricin acetyltransferase are for example described in U.S. Pat. Nos. 5,561,236; 5,648,477; 5,646,024; 5,273,894; 5,637,489; 5,276,268; 5,739,082; 5,908,810 and 7,112,665. Further herbicide-tolerant plants are also plants that are made tolerant to the herbicides inhibiting the enzyme hydroxyphenylpyruvatedioxygenase (HPPD). Hydroxyphenylpyruvatedioxygenases are enzymes that catalyze the reaction in which para-hydroxyphenylpyruvate (HPP) is transformed into homogentisate. Plants tolerant to HPPD-inhibitors can be transformed with a gene encoding a naturally-occurring resistant HPPD enzyme, or a gene encoding a mutated or chimeric HPPD enzyme as described in WO 96/38567, WO 99/24585, WO 99/24586, WO 2009/144079, WO 2002/046387, or U.S. Pat. No. 6,768,044. Tolerance to HPPD-inhibitors can also be obtained by transforming plants with genes encoding certain enzymes enabling the formation of homogentisate despite the inhibition of the native HPPD enzyme by the HPPD-inhibitor. Such plants and genes are described in WO 99/34008 and WO 02/36787. Tolerance of plants to HPPD inhibitors can also be improved by transforming plants with a gene encoding an enzyme having prephenate deshydrogenase (PDH) activity in addition to a gene encoding an HPPD-tolerant enzyme, as described in WO 2004/024928. Further, plants can be made more tolerant to HPPD-inhibitor herbicides by adding into their genome a gene encoding an enzyme capable of metabolizing or degrading HPPD inhibitors, such as the CYP450 enzymes shown in WO 2007/103567 and WO 2008/150473.

Still further herbicide resistant plants are plants that are made tolerant to acetolactate synthase (ALS) inhibitors. Known ALS-inhibitors include, for example, sulfonylurea, imidazolinone, triazolopyrimidines, pryimidinyoxy(thio)benzoates, and/or sulfonylaminocarbonyltriazolinone herbicides. Different mutations in the ALS enzyme (also known as acetohydroxyacid synthase, AHAS) are known to confer tolerance to different herbicides and groups of herbicides, as described for example in Tranel and Wright (2002, Weed Science 50:700-712), but also, in U.S. Pat. Nos. 5,605,011, 5,378,824, 5,141,870, and 5,013,659. The production of sulfonylurea-tolerant plants and imidazolinone-tolerant plants is described in U.S. Pat. Nos. 5,605,011; 5,013,659; 5,141,870; 5,767,361; 5,731,180; 5,304,732; 4,761,373; 5,331,107; 5,928,937; and 5,378,824; and international publication WO 96/33270. Other imidazolinone-tolerant plants are also described in for example WO 2004/040012, WO 2004/106529, WO 2005/020673, WO 2005/093093, WO 2006/007373, WO 2006/015376, WO 2006/024351, and WO 2006/060634. Further sulfonylurea- and imidazolinone-tolerant plants are also described in for example WO 07/024,782 and U.S. Patent Application No. 61/288,958.

Other plants tolerant to imidazolinone and/or sulfonylurea can be obtained by induced mutagenesis, selection in cell cultures in the presence of the herbicide or mutation breeding as described for example for soybeans in U.S. Pat. No. 5,084,082, for rice in WO 97/41218, for sugar beet in U.S. Pat. No. 5,773,702 and WO 99/057965, for lettuce in U.S. Pat. No. 5,198,599, or for sunflower in WO 01/065922.

Plants or plant cultivars (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

An “insect-resistant transgenic plant”, as used herein, includes any plant containing at least one transgene comprising a coding sequence encoding:
1) an insecticidal crystal protein from Bacillus thuringiensis or an insecticidal portion thereof, such as the insecticidal crystal proteins listed by Crickmore et al. (1998, Microbiology and Molecular Biology Reviews, 62: 807-813), updated by Crickmore et al. (2005) at the Bacillus thuringiensis toxin nomenclature, online at: http://www.lifesci.sussex.ac.uk/Home/Neil_Crickmore/Bt/), or insecticidal portions thereof, e.g., proteins of the Cry protein classes Cry1Ab, Cry1Ac, Cry1B, Cry1C, Cry1D, Cry1F, Cry2Ab, Cry3Aa, or Cry3Bb or insecticidal portions thereof (e.g. EP 1999141 and WO 2007/107302), or such proteins encoded by synthetic genes as e.g. described in and U.S. patent application Ser. No. 12/249,016; or
2) a crystal protein from Bacillus thuringiensis or a portion thereof which is insecticidal in the presence of a second other crystal protein from Bacillus thuringiensis or a portion thereof, such as the binary toxin made up of the Cry34 and Cry35 crystal proteins (Moellenbeck et al. 2001, Nat. Biotechnol. 19: 668-72; Schnepf et al. 2006, Applied Environm. Microbiol. 71, 1765-1774) or the binary toxin made up of the Cry1A or Cry1F proteins and the Cry2Aa or Cry2Ab or Cry2Ae proteins (U.S. patent application Ser. No. 12/214,022 and EP 08010791.5); or
3) a hybrid insecticidal protein comprising parts of different insecticidal crystal proteins from Bacillus thuringiensis, such as a hybrid of the proteins of 1) above or a hybrid of the proteins of 2) above, e.g., the Cry1A. 105 protein produced by corn event MON89034 (WO 2007/027777); or
4) a protein of any one of 1) to 3) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation, such as the Cry3Bb1 protein in corn events MON863 or MON88017, or the Cry3A protein in corn event MIR604; or
5) an insecticidal secreted protein from Bacillus thuringiensis or Bacillus cereus, or an insecticidal portion thereof, such as the vegetative insecticidal (VIP) proteins listed at: http://www.lifesci.sussex.ac.uk/home/Neil_Crickmore/Bt/vip.html, e.g., proteins from the VIP3Aa protein class; or
6) a secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins (WO 94/21795); or
7) a hybrid insecticidal protein comprising parts from different secreted proteins from Bacillus thuringiensis or Bacillus cereus, such as a hybrid of the proteins in 1) above or a hybrid of the proteins in 2) above; or
8) a protein of any one of 5) to 7) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation (while still encoding an insecticidal protein), such as the VIP3Aa protein in cotton event COT102; or
9) a secreted protein from Bacillus thuringiensis or Bacillus cereus which is insecticidal in

the presence of a crystal protein from Bacillus thuringiensis, such as the binary toxin made up of VIP3 and Cry1A or Cry1F (U.S. Patent Appl. No. 61/126,083 and 61/195,019), or the binary toxin made up of the VIP3 protein and the Cry2Aa or Cry2Ab or Cry2Ae proteins (U.S. patent application Ser. No. 12/214,022 and EP 08010791.5).
10) a protein of 9) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation (while still encoding an insecticidal protein)

Of course, an insect-resistant transgenic plant, as used herein, also includes any plant comprising a combination of genes encoding the proteins of any one of the above classes 1 to 10. In one embodiment, an insect-resistant plant contains more than one transgene encoding a protein of any one of the above classes 1 to 10, to expand the range of target insect species affected when using different proteins directed at different target insect species, or to delay insect resistance development to the plants by using different proteins insecticidal to the same target insect species but having a different mode of action, such as binding to different receptor binding sites in the insect.

An “insect-resistant transgenic plant”, as used herein, further includes any plant containing at least one transgene comprising a sequence producing upon expression a double-stranded RNA which upon ingestion by a plant insect pest inhibits the growth of this insect pest, as described e.g. in WO 2007/080126, WO 2006/129204, WO 2007/074405, WO 2007/080127 and WO 2007/035650.

Plants or plant cultivars (obtained by plant biotechnology methods such as genetic engineering) which may also be treated according to the invention are tolerant to abiotic stresses. Such plants can be obtained by genetic transformation, or by selection of plants containing a mutation imparting such stress resistance. Particularly useful stress tolerance plants include:
1) plants which contain a transgene capable of reducing the expression and/or the activity of poly(ADP-ribose) polymerase (PARP) gene in the plant cells or plants as described in WO 00/04173, WO/2006/045633, EP 04077984.5, or EP 06009836.5.
2) plants which contain a stress tolerance enhancing transgene capable of reducing the expression and/or the activity of the PARG encoding genes of the plants or plants cells, as described e.g. in WO 2004/090140.
3) plants which contain a stress tolerance enhancing transgene coding for a plant-functional enzyme of the nicotineamide adenine dinucleotide salvage synthesis pathway including nicotinamidase, nicotinate phosphoribosyltransferase, nicotinic acid mononucleotide adenyl transferase, nicotinamide adenine dinucleotide synthetase or nicotine amide phosphorybosyltransferase as described e.g. in EP 04077624.7, WO 2006/133827, PCT/EP07/002,433, EP 1999263, or WO 2007/107326.

Plants or plant cultivars (obtained by plant biotechnology methods such as genetic engineering) which may also be treated according to the invention show altered quantity, quality and/or storage-stability of the harvested product and/or altered properties of specific ingredients of the harvested product such as:
1) transgenic plants which synthesize a modified starch, which in its physical-chemical characteristics, in particular the amylose content or the amylose/amylopectin ratio, the degree of branching, the average chain length, the side chain distribution, the viscosity behaviour, the gelling strength, the starch grain size and/or the starch grain morphology, is changed in comparison with the synthesised starch in wild type plant cells or plants, so that this is better suited for special applications. Said transgenic plants synthesizing a modified starch are disclosed, for example, in EP 0571427, WO 95/04826, EP 0719338, WO 96/15248, WO 96/19581, WO 96/27674, WO 97/11188, WO 97/26362, WO 97/32985, WO 97/42328, WO 97/44472, WO 97/45545, WO 98/27212, WO 98/40503, WO99/58688, WO 99/58690, WO 99/58654, WO 00/08184, WO 00/08185, WO 00/08175, WO 00/28052, WO 00/77229, WO 01/12782, WO 01/12826, WO 02/101059, WO 03/071860, WO 2004/056999, WO 2005/030942, WO 2005/030941, WO 2005/095632, WO 2005/095617, WO 2005/095619, WO 2005/095618, WO 2005/123927, WO 2006/018319, WO 2006/103107, WO 2006/108702, WO 2007/009823, WO 00/22140, WO 2006/063862, WO 2006/072603, WO 02/034923, EP 06090134.5, EP 06090228.5, EP 06090227.7, EP 07090007.1, EP 07090009.7, WO 01/14569, WO 02/79410, WO 03/33540, WO 2004/078983, WO 01/19975, WO 95/26407, WO 96/34968, WO 98/20145, WO 99/12950, WO 99/66050, WO 99/53072, U.S. Pat. No. 6,734,341, WO 00/11192, WO 98/22604, WO 98/32326, WO 01/98509, WO 01/98509, WO 2005/002359, U.S. Pat. No. 5,824,790, U.S. Pat. No. 6,013,861, WO 94/04693, WO 94/09144, WO 94/11520, WO 95/35026, WO 97/20936
2) transgenic plants which synthesize non starch carbohydrate polymers or which synthesize non starch carbohydrate polymers with altered properties in comparison to wild type plants without genetic modification. Examples are plants producing polyfructose, especially of the inulin and levan-type, as disclosed in EP 0663956, WO 96/01904, WO 96/21023, WO 98/39460, and WO 99/24593, plants producing alpha-1,4-glucans as disclosed in WO 95/31553, US 2002031826, U.S. Pat. No. 6,284,479, U.S. Pat. No. 5,712,107, WO 97/47806, WO 97/47807, WO 97/47808 and WO 00/14249, plants producing alpha-1,6 branched alpha-1,4-glucans, as disclosed in WO 00/73422, plants producing alternan, as disclosed in e.g. WO 00/47727, WO 00/73422, EP 06077301.7, U.S. Pat. No. 5,908,975 and EP 0728213,
3) transgenic plants which produce hyaluronan, as for example disclosed in WO 2006/032538, WO 2007/039314, WO 2007/039315, WO 2007/039316, JP 2006304779, and WO 2005/012529.
4) transgenic plants or hybrid plants, such as onions with characteristics such as ‘high soluble solids content’, ‘low pungency’ (LP) and/or ‘long storage’ (LS), as described in U.S. patent application Ser. No. 12/020,360 and 61/054,026.

Plants or plant cultivars (that can be obtained by plant biotechnology methods such as genetic engineering) which may also be treated according to the invention are plants, such as cotton plants, with altered fiber characteristics. Such plants can be obtained by genetic transformation, or by selection of plants contain a mutation imparting such altered fiber characteristics and include:
a) Plants, such as cotton plants, containing an altered form of cellulose synthase genes as described in WO 98/00549
b) Plants, such as cotton plants, containing an altered form of rsw2 or rsw3 homologous nucleic acids as described in WO 2004/053219
c) Plants, such as cotton plants, with increased expression of sucrose phosphate synthase as described in WO 01/17333
d) Plants, such as cotton plants, with increased expression of sucrose synthase as described in WO 02/45485
e) Plants, such as cotton plants, wherein the timing of the plasmodesmatal gating at the basis of the fiber cell is altered, e.g. through downregulation of fiber-selective 0-1,3-glucanase as described in WO 2005/017157, or as described in EP 08075514.3 or U.S. Patent Appl. No. 61/128,938
f) Plants, such as cotton plants, having fibers with altered reactivity, e.g. through the expression of N-acetylglucosaminetransferase gene including nodC and chitin synthase genes as described in WO 2006/136351

Plants or plant cultivars (that can be obtained by plant biotechnology methods such as genetic engineering) which may also be treated according to the invention are plants, such as oilseed rape or related Brassica plants, with altered oil profile characteristics. Such plants can be obtained by genetic transformation, or by selection of plants contain a mutation imparting such altered oil profile characteristics and include:
a) Plants, such as oilseed rape plants, producing oil having a high oleic acid content as described e.g. in U.S. Pat. No. 5,969,169, U.S. Pat. No. 5,840,946 or U.S. Pat. No. 6,323,392 or U.S. Pat. No. 6,063,947
b) Plants such as oilseed rape plants, producing oil having a low linolenic acid content as described in U.S. Pat. No. 6,270,828, U.S. Pat. No. 6,169,190, or U.S. Pat. No. 5,965,755
c) Plant such as oilseed rape plants, producing oil having a low level of saturated fatty acids as described e.g. in U.S. Pat. No. 5,434,283 or U.S. patent application Ser. No. 12/668,303

Plants or plant cultivars (that can be obtained by plant biotechnology methods such as genetic engineering) which may also be treated according to the invention are plants, such as oilseed rape or related Brassica plants, with altered seed shattering characteristics. Such plants can be obtained by genetic transformation, or by selection of plants contain a mutation imparting such altered seed shattering characteristics and include plants such as oilseed rape plants with delayed or reduced seed shattering as described in U.S. Patent Appl. No. 61/135,230 WO09/068,313 and WO10/006,732. Particularly useful transgenic plants which may be treated according to the invention are plants containing transformation events, or combination of transformation events, that are the subject of petitions for non-regulated status, in the United States of America, to the Animal and Plant Health Inspection Service (APHIS) of the United States Department of Agriculture (USDA) whether such petitions are granted or are still pending. At any time this information is readily available from APHIS (4700 River Road Riverdale, Md. 20737, USA), for instance on its internet site (URL http://www.aphis.usda.gov/brs/not_reg.html). On the filing date of this application the petitions for nonregulated status that were pending with APHIS or granted by APHIS were those listed in table B which contains the following information:
Petition: the identification number of the petition. Technical descriptions of the transformation events can be found in the individual petition documents which are obtainable from APHIS, for example on the APHIS website, by reference to this petition number. These descriptions are herein incorporated by reference.
Extension of Petition: reference to a previous petition for which an extension is requested.
Institution: the name of the entity submitting the petition.
Regulated article: the plant species concerned.
Transgenic phenotype: the trait conferred to the plants by the transformation event.
Transformation event or line: the name of the event or events (sometimes also designated as lines or lines) for which nonregulated status is requested.
APHIS documents: various documents published by APHIS in relation to the Petition and which can be requested with APHIS.

Additional particularly useful plants containing single transformation events or combinations of transformation events are listed for example in the databases from various national or regional regulatory agencies (see for example http://gmoinfo.jrc.it/gmp_browse.aspx and http://www.agbios.com/dbase.php).

Particularly useful transgenic plants which may be treated according to the invention are plants containing transformation events, or a combination of transformation events, and that are listed for example in the databases for various national or regional regulatory agencies including Event 1143-14A (cotton, insect control, not deposited, described in WO 2006/128569); Event 1143-51B (cotton, insect control, not deposited, described in WO 2006/128570); Event 1445 (cotton, herbicide tolerance, not deposited, described in US-A 2002-120964 or WO 02/034946); Event 17053 (rice, herbicide tolerance, deposited as PTA-9843, described in WO 2010/117737); Event 17314 (rice, herbicide tolerance, deposited as PTA-9844, described in WO 2010/117735); Event 281-24-236 (cotton, insect control—herbicide tolerance, deposited as PTA-6233, described in WO 2005/103266 or US-A 2005-216969); Event 3006-210-23 (cotton, insect control—herbicide tolerance, deposited as PTA-6233, described in US-A 2007-143876 or WO 2005/103266); Event 3272 (corn, quality trait, deposited as PTA-9972, described in WO 2006/098952 or US-A 2006-230473); Event 40416 (corn, insect control—herbicide tolerance, deposited as ATCC PTA-11508, described in WO 2011/075593); Event 43A47 (corn, insect control—herbicide tolerance, deposited as ATCC PTA-11509, described in WO 2011/075595); Event 5307 (corn, insect control, deposited as ATCC PTA-9561, described in WO 2010/077816); Event ASR-368 (bent grass, herbicide tolerance, deposited as ATCC PTA-4816, described in US-A 2006-162007 or WO 2004/053062); Event B16 (corn, herbicide tolerance, not deposited, described in US-A 2003-126634); Event BPS-CV127-9 (soybean, herbicide tolerance, deposited as NCIMB No. 41603, described in WO 2010/080829); Event CE43-67B (cotton, insect control, deposited as DSM ACC2724, described in US-A 2009-217423 or WO2006/128573); Event CE44-69D (cotton, insect control, not deposited, described in US-A 2010-0024077); Event CE44-69D (cotton, insect control, not deposited, described in WO 2006/128571); Event CE46-02A (cotton, insect control, not deposited, described in WO 2006/128572); Event COT102 (cotton, insect control, not deposited, described in US-A 2006-130175 or WO 2004/039986); Event COT202 (cotton, insect control, not deposited, described in US-A 2007-067868 or WO 2005/054479); Event COT203 (cotton, insect control, not deposited, described in WO 2005/054480); Event DAS40278 (corn, herbicide tolerance, deposited as ATCC PTA-10244, described in WO 2011/022469); Event DAS-59122-7 (corn, insect control—herbicide tolerance, deposited as ATCC PTA 11384, described in US-A 2006-070139); Event DAS-59132 (corn, insect control—herbicide tolerance, not deposited, described in WO 2009/100188); Event DAS68416 (soybean, herbicide tolerance, deposited as ATCC PTA-10442, described in WO 2011/066384 or WO 2011/066360); Event DP-098140-6 (corn, herbicide tolerance, deposited as ATCC PTA-8296, described in US-A 2009-137395 or WO 2008/112019); Event DP-305423-1 (soybean, quality trait, not deposited, described in US-A 2008-312082 or WO 2008/054747); Event DP-32138-1 (corn, hybridization system, deposited as ATCC PTA-9158, described in US-A 2009-0210970 or WO 2009/103049); Event DP-356043-5 (soybean, herbicide tolerance, deposited as ATCC PTA-8287, described in US-A 2010-0184079 or WO 2008/002872); Event EE-1 (brinjal, insect control, not deposited, described in WO 2007/091277); Event FI1117 (corn, herbicide tolerance, deposited as ATCC 209031, described in US-A 2006-059581 or WO 98/044140); Event GA21 (corn, herbicide tolerance, deposited as ATCC 209033, described in US-A 2005-086719 or WO 98/044140); Event GG25 (corn, herbicide tolerance, deposited as ATCC 209032, described in US-A 2005-188434 or WO 98/044140); Event GHB119 (cotton, insect control—herbicide tolerance, deposited as ATCC PTA-8398, described in WO 2008/151780); Event GHB614 (cotton, herbicide tolerance, deposited as ATCC PTA-6878, described in US-A 2010-050282 or WO 2007/017186); Event GJ11 (corn, herbicide tolerance, deposited as ATCC 209030, described in US-A 2005-188434 or WO 98/044140); Event GM RZ13 (sugar beet, virus resistance, deposited as NCIMB-41601, described in WO 2010/076212); Event H7-1 (sugar beet, herbicide tolerance, deposited as NCIMB 41158 or NCIMB 41159, described in US-A 2004-172669 or WO 2004/074492); Event JOPLIN1 (wheat, disease tolerance, not deposited, described in US-A 2008-064032); Event LL27 (soybean, herbicide tolerance, deposited as NCIMB41658, described in WO 2006/108674 or US-A 2008-320616); Event LL55 (soybean, herbicide tolerance, deposited as NCIMB 41660, described in WO 2006/108675 or US-A 2008-196127); Event LLcotton25 (cotton, herbicide tolerance, deposited as ATCC PTA-3343, described in WO 03/013224 or US-A 2003-097687); Event LLRICE06 (rice, herbicide tolerance, deposited as ATCC-23352, described in U.S. Pat. No. 6,468,747 or WO 00/026345); Event LLRICE601 (rice, herbicide tolerance, deposited as ATCC PTA-2600, described in US-A 2008-2289060 or WO 00/026356); Event LY038 (corn, quality trait, deposited as ATCC PTA-5623, described in US-A 2007-028322 or WO 2005/061720); Event MIR162 (corn, insect control, deposited as PTA-8166, described in US-A 2009-300784 or WO 2007/142840); Event MIR604 (corn, insect control, not deposited, described in US-A 2008-167456 or WO 2005/103301); Event MON15985 (cotton, insect control, deposited as ATCC PTA-2516, described in US-A 2004-250317 or WO 02/100163); Event MON810 (corn, insect control, not deposited, described in US-A 2002-102582); Event MON863 (corn, insect control, deposited as ATCC PTA-2605, described in WO 2004/011601 or US-A 2006-095986); Event MON87427 (corn, pollination control, deposited as ATCC PTA-7899, described in WO 2011/062904); Event MON87460 (corn, stress tolerance, deposited as ATCC PTA-8910, described in WO 2009/111263 or US-A 2011-0138504); Event MON87701 (soybean, insect control, deposited as ATCC PTA-8194, described in US-A 2009-130071 or WO 2009/064652); Event MON87705 (soybean, quality trait—herbicide tolerance, deposited as ATCC PTA-9241, described in US-A 2010-0080887 or WO 2010/037016); Event MON87708 (soybean, herbicide tolerance, deposited as ATCC PTA9670, described in WO 2011/034704); Event MON87754 (soybean, quality trait, deposited as ATCC PTA-9385, described in WO 2010/024976); Event MON87769 (soybean, quality trait, deposited as ATCC PTA-8911, described in US-A 2011-0067141 or WO 2009/102873); Event MON88017 (corn, insect control—herbicide tolerance, deposited as ATCC PTA-5582, described in US-A 2008-028482 or WO 2005/059103); Event MON88913 (cotton, herbicide tolerance, deposited as ATCC PTA-4854, described in WO 2004/072235 or US-A 2006-059590); Event MON89034 (corn, insect control, deposited as ATCC PTA-7455, described in WO 2007/140256 or US-A 2008-260932); Event MON89788 (soybean, herbicide tolerance, deposited as ATCC PTA-6708, described in US-A 2006-282915 or WO 2006/130436); Event MS11 (oilseed rape, pollination control—herbicide tolerance, deposited as ATCC PTA-850 or PTA-2485, described in WO 01/031042); Event MS8 (oilseed rape, pollination control—herbicide tolerance, deposited as ATCC PTA-730, described in WO 01/041558 or US-A 2003-188347); Event NK603 (corn, herbicide tolerance, deposited as ATCC PTA-2478, described in US-A 2007-292854); Event PE-7 (rice, insect control, not deposited, described in WO 2008/114282); Event RF3 (oilseed rape, pollination control—herbicide tolerance, deposited as ATCC PTA-730, described in WO 01/041558 or US-A 2003-188347); Event RT73 (oilseed rape, herbicide tolerance, not deposited, described in WO 02/036831 or US-A 2008-070260); Event T227-1 (sugar beet, herbicide tolerance, not deposited, described in WO 02/44407 or US-A 2009-265817); Event T25 (corn, herbicide tolerance, not deposited, described in US-A 2001-029014 or WO 01/051654); Event T304-40 (cotton, insect control—herbicide tolerance, deposited as ATCC PTA-8171, described in US-A 2010-077501 or WO 2008/122406); Event T342-142 (cotton, insect control, not deposited, described in WO 2006/128568); Event TC1507 (corn, insect control—herbicide tolerance, not deposited, described in US-A 2005-039226 or WO 2004/099447); Event VIP1034 (corn, insect control—herbicide tolerance, deposited as ATCC PTA-3925., described in WO 03/052073), Event 32316 (corn, insect control-herbicide tolerance, deposited as PTA-11507, described in WO 2011/084632), Event 4114 (corn, insect control-herbicide tolerance, deposited as PTA-11506, described in WO 2011/084621).

The negative effects of the seed treatment and the protective effect of the lipochito-oligosaccharide compound on the germination and/or vitality of treated seeds, potentially including root and/or shoot development, can be assessed in several kinds of experiments. Such experiments may include the following 3 treatments:
control treatment;
only seed treatment, with or without further hydrating and drying treatment, including at least one fungicidal, insecticidal, nematicidal or acaricidal active ingredient; and
only seed treatment, with or without further hydrating and drying treatment, including at least one fungicidal, insecticidal, nematicidal or acaricidal active ingredient associated with a lipochito-oligosaccharide.

Typically, control seeds are defined as raw seeds, which are cleaned and sorted, but which have not been exposed to any type of seed treatment, including or not including hydrating and drying treatment as explained earlier. Negative effects of the seed treatment are defined as a decrease in germination and/or vitality of the ‘only’ chemical treated seeds in comparison with germination and/or vitality of control seeds. The positive effects of the lipochito-oligosaccharide compound on the germination and vitality of treated seeds are defined as a decrease or absence of negative effects of the seed treatment.

The experiments introduced above can be carried out under controlled conditions in, amongst others, the climate chamber, the greenhouse or the germination cabinet in the laboratory, as well as in the field. Under controlled conditions, germinations tests such as described in the ISTA (International Seed Testing Association) handbook as well as tests commonly known in the art as vigour tests can be carried out (ISTA, 2005. International rules for seed testing; AOSA, 1973. Seed vigor testing handbook. Contribution no. 32 to the handbook on seed testing. Association of Official Seed Analysts (AOSA)). Typically, germination tests include tests on or between filter paper or blotter, as well as tests on/in sand, compost or soil. Moisture, temperature and light regimes are optimal for germination (see e.g. ISTA, 2005. International rules for seed testing). Generally, seedlings in a germination test are evaluated when all essential structures are visible. Then, all seedlings are counted that have germinated ‘normally’ according to e.g. the ISTA guidelines. The number of abnormal, multigerm or dead seeds is recorded as well. Typically, this type of evaluation is carried out at least at two times during the germination process; a first time when all essential structures are visible, and a final count. The time of final count depends on plant species and ambient conditions. Generally, the final count is taken between 5 and 60 days after sowing. Alternatively to the evaluation of seedlings explained above, germination could be assessed in all treatments from the moment any seedling has protruded the seed coat or pericarp in any of the treatments. Subsequently, countings can be performed every other day, once a day or even multiple times a day, depending on the speed of germination. In this way, the whole process of germination can be assessed.

Vigour tests are carried out to assess seed vigour. This is a concept describing those seed properties associated with the potential for a rapid, uniform emergence and development of normal seedlings under a wide range of field conditions. The results of such tests are a better predictor of seed performance in the field than standard germination tests under optimal conditions (ISTA, 2005. International rules for seed testing; AOSA, 1973. Seed vigor testing handbook. Contribution no. 32 to the handbook on seed testing. Association of Official Seed Analysts (AOSA)). Specific vigour tests are stress tests, in which seeds are stressed either prior to imbibition or during germination. In stress tests the substratum could range from sand or an artificial substrate like coconut fibres, to a real arable soil. Besides, or in addition, the climatic conditions are higher or lower than the ones commonly accepted as being optimal. A well known example of a vigour stress test is the cold test which is often carried out on corn seeds. In this test the seeds are sown in arable soil and kept for 7 days at a temperature of 10° C. (cold phase). Thereafter the seeds are kept at 25° C. for another 7 days, after which maximum germination and seedling quality is assessed (Jonitz, A and Leist, N. 2003. Pflantzenschutz-Nachrichten Bayer, 56(1), pp 173-207). Also for vigour tests, germination could be counted at two specific moments, but also at many moments in between in order to construct a view of the whole germination process. For seeds covered with substrate, the counting of emergence in all treatments could start from the moment any emerging seedling is visible above the substrate in any of the treatments involved. Subsequently, emergence could be counted at frequent intervals depending on the progress of emergence. At the final count, the seedlings can be arranged in classes that indicate whether or not the seedling is able to further develop into a satisfactory plant. In this document, these classes are called vitality classes. The seedlings are classified as normal, slightly damaged or abnormal. Seeds that have not germinated or emerged are classified as dead seeds.

Besides the experiments under controlled conditions, tests could also be performed in the field. Due to the, in most cases, less optimal conditions in the field, emergence is counted at a later stage, or from a later stage onwards, than the first count for a certain species under controlled conditions. In addition to a vitality evaluation of the seedlings, yield could be assessed at the end of the growing period of the crop.

Depending on their particular physical and/or chemical properties, the fungicides, insecticides, acaricides, and nematicides according to the invention can be converted into the customary formulations, such as solutions, emulsions, suspensions, powders, dusts, foams, pastes, soluble powders, granules, aerosols, suspoemulsion concentrates, natural and synthetic materials impregnated with active compound and microencapsulations in polymeric substances and in coating compositions for seeds, and ULV cool and warm fogging formulations.

These formulations are produced in a known manner, for example by mixing the active compounds or active compound combinations with extenders, that is liquid solvents, liquefied gases under pressure, and/or solid carriers, optionally with the use of surfactants, that is emulsifiers and/or dispersants, and/or foam formers.

If the extender used is water, it is also possible to employ, for example, organic solvents as auxiliary sol-vents. Essentially, suitable liquid solvents are: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide or dimethyl sulphoxide, or else water.

Liquefied gaseous extenders or carriers are to be understood as meaning liquids which are gaseous at standard temperature and under atmospheric pressure, for example aerosol propellants such as butane, propane, nitrogen and carbon dioxide.

Suitable solid carriers are for example: ammonium salts and ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, pumice, marble, sepiolite and dolomite, or else synthetic granules of inorganic and organic meals, and granules of organic material such as sawdust, coconut shells, maize cobs and tobacco stalks.

Suitable emulsifiers and/or foam formers are for example: nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates. Suitable dispersants are: for example lignosulphite waste liquors and methylcellulose.

Tackifiers such as carboxymethylcellulose, natural and synthetic polymers in the form of powders, granules or latices, such as gum arabic, polyvinyl alcohol and polyvinylacetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The active compound content of the use forms prepared from the commercial formulations may be varied within wide ranges. The concentration of active compound of the use forms for controlling animal pests, such as insects and acarids, may be from 0.0000001 to 95% by weight of active compound and is preferably from 0.0001 to 25% by weight. Application is in a manner adapted to the use forms.

The present invention is further related to the use of a lipochito-oligosaccharide derivative for improving the germination of seed, or the vitality of the seedling emerging from said seed, of an agricultural, vegetable or flower crop treated with a seed treatment containing at least one fungicidal, insecticidal, acaricidal or nematicidal compound, characterized in that said seed treatment contains further said lipochito-oligosaccharide derivative and wherein said lipochito-oligosaccharide derivative is as herein defined. Said seed treatment may further comprises the steps of hydrating the seed, then drying the seed, before treating it with the active ingredients.

The preferred, particularly preferred or most particularly preferred features of this invention can be combined in any way to produce embodiments that solve the technical problem underlying this invention.

### Example 1

### Germination Rate of Wheat in Combination with Fungicides

### Compound A1

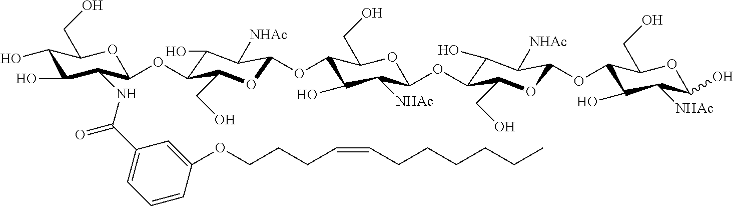

The test is performed under greenhouse conditions.

Wheat kernels were treated with different fungicides (25 g/dt in NMP) or a mixture of compound A1 (0.1 mg/ha in 1:1, acetonitril/water) with the fungicides. Kernels were planted in soil and grown in the greenhouse at 15° C., 70% humidity, 14 h day/light cycle for 7 days.

Controls are performed in the same conditions in the absence of active ingredients. Assessment consisted of counting seedlings per treatment.

| treatment | % germination |
|---|---|
| fluoxastrobin | 4 |
| fluoxastrobin + compound | 17 |
| A1 | |
| tebuconazole | 21 |
| tebuconazole + compound | 32 |
| A1 | |
| fludioxonil | 23 |
| fludioxonil + compound A1 | 40 |
| Penflufen | 47 |
| penflufen + compound A1 | 61 |
| solvent control | 69 |

Application of the fungicides at 25 g/dt reduce the germination rate significantly in comparison to the solvent control. Seed treatment of the fungicides in combination with compound A1 significantly increases the reduced germination rate.

### Example 2

### Germination Rate of Wheat and Maize in Combination with Insecticides

The test was performed under greenhouse conditions.

Kernels were treated with different insecticides (ready formulated) or a mixture of compound A1 (1 mg/ha in 1:1, acetonitril/water) with the insecticides. Kernels were planted in soil and grown in the greenhouse at 20° C., 80% humidity, 12 h day/light cycle for 4 days (wheat) and at 10° C., 80% humidity, 12 h day/light cycle for 9 days (maize).

Controls are performed in the same conditions in the absence of active ingredients. Assessment consisted of counting seedlings per treatment.

| | | germination % | |
|---|---|---|---|
| | concentration | maize | wheat |
| treatment | [mg ai/corn] | 9 d | 4 d |
| thiacloprid | 1.00 | | 9 |
| thiacloprid + compound A1 | 1.00 | | 20 |
| clothianidin | 1.25 | 8 | |
| clothianidin + compound A1 | 1.25 | 15 | |
| imidacloprid | 0.75 | 0 | |
| imidacloprid + compound A1 | 0.75 | 8 | |
| solvent control | | 17 | 64 |

Application of the insecticides reduced the germination rate significantly in comparison to the solvent control. Seed treatment of the insecticides in combination with compound A1 increases the reduced germination rate.

1. Method to improve the germination of seed, or the vitality of the seedling emerging from said seed, of an agricultural, vegetable or flower crop treated with a seed treatment containing at least one fungicidal, insecticidal, acaricidal or nematicidal compound, characterized in that said seed treatment contains further a lipochito-oligosaccharide derivative.

2. The method according to claim 1 wherein said lipochito-oligosaccharide derivative is a natural one.

3. The method according to claim 1 wherein said lipochito-oligosaccharide derivative is a compound having an oligomeric backbone of β-1,4-linked N-acetyl-D-glucosamine residues with an N-linked fatty acyl chain at the non-reducing end.

4. The method according to claim 1 wherein said lipochito-oligosaccharide derivative is a compound of formula (I) 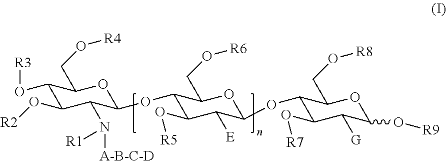
in which
n represents 1, 2 or 3;
A represents a substituent chosen from —C(O)—, —C(S)—, —CH2-, —CHR10-, —CR10R11-, —C(O)O—, —C(O)S—, —C(S)O—, —C(S)S—, —C(O)NH—, —C(NH)NH— and —C(S)NH—;
B represents
an arylene;
a heteroarylene comprising 1 or 2 hetero atoms chosen from nitrogen, oxygen and sulfur;
a naphthylene;
a heteronaphthylene comprising 1 or 2 hetero atoms chosen from nitrogen, oxygen and sulfur;
a divalent radical derived from 2 fused aromatic rings of 5 or 6 atoms each;
a divalent radical derived from 2 fused aromatic or heteroaromatic rings of 5 or 6 atoms each, comprising 1 or 2 hetero atoms chosen from nitrogen, oxygen and sulfur;
a biphenylene;
or a heterobiphenylene comprising 1 or 2 hetero atoms chosen from nitrogen, oxygen and sulfur; these groups possibly being substituted with one or two substituents R12 and R13 chosen, independently of each other, from halogen, CN, C(O)OR14, C(O)NR15R16, CF3, OCF3, —NO2, N3, OR14, SR14, NR15R16 and C1-6-alkyl;
C represents a substituent chosen from —O—, —S—, —CH2-, —CHR17-, —CR17R18- and —NR19;
D represents a linear or branched, saturated or unsaturated hydrocarbon-based chain containing from 2 to 20 carbon atoms;
E and G represent, independently of each other, a substituent chosen from H, OH, OR20, NH2 and NHR20;
R1 represents a substituent chosen from H, C1-6-alkyl, C(O)H and C(O)CH3;
R2, R3, R6, R14, R15, R16 and R19 represent, independently of each other, a substituent chosen from H, C1-6-alkyl, C(O)C1-6-alkyl, —C(S)C1-6-alkyl, —C(O)OC1-6-alkyl, —C(O)NH2, —C(S)NH2, —C(NH)NH2, —C(O)NHC1-6-alkyl, —C(S)NHC1-6-alkyl and —C(NH)NHC1-6-alkyl;
R4 represents a substituent chosen from H, C1-6-alkyl and R21;
R5 represents a substituent chosen from H, C1-6-alkyl, fucosyl and R22;
R7 represents a substituent chosen from H, C1-6-alkyl, arabinosyl and R23;
R8 represents a substituent chosen from H, C1-6-alkyl, fucosyl, methylfucosyl, sulfofucosyl, acetylfucosyl, arabinosyl, SO3H, SO3Li, SO3Na, SO3K, SO3N(C1-8alkyl)4 and R24;
R9 represents a substituent chosen from H, C1-6-alkyl, mannose, glycerol and R25;
R10, R11, R17 and R18 represent, independently of each other, a substituent chosen from C1-6-alkyl and F;
R20, R21, R22, R23, R24 and R25 represent, independently of each other, a substituent chosen from C(O)C1-6-alkyl, —C(S)C1-6-alkyl, —C(O)OC1-6-alkyl, —C(O)NH2, —C(S)NH2, —C(NH)NH2, —C(O)NHC1-6-alkyl, —C(S)NHC1-6-alkyl and —C(NH)NHC1-6-alkyl; and also the possible geometrical and/or optical isomers, enantiomers and/or diastereoisomers, tautomers, salts, N-oxides, sulfoxides, sulfones, metal or metalloid complexes thereof, which are agriculturally acceptable. Among the compounds defined above, the most important compounds are the salts, more particularly the lithium, sodium, potassium or tetraalkylammonium salts;

5. The method according to claim 4 wherein
n represents 2 or 3;
A represents —C(O)—;
B represents a phenylene;
C represents —O—;
D represents a linear hydrocarbon-based chain containing 11 carbons, which is saturated, or unsaturated between carbons 4 and 5;
E and G represent NHC(O)CH₃;
R¹ represents H, CH₃ or C(O)CH₃;
R², R³, R⁵, R⁶, R⁷ and R⁹ represent H;
R⁴ represents H, C(O)CH₃ or C(O)NH₂;
R⁸ represents H, SO₃H, SO₃L₁, SO₃Na, SO₃K, SO₃N(C1-8alkyl)₄, fucosyl or methylfucosyl.

6. The method according to claim 1 wherein said lipochito-oligosaccharide is chosen in the list consisting of: 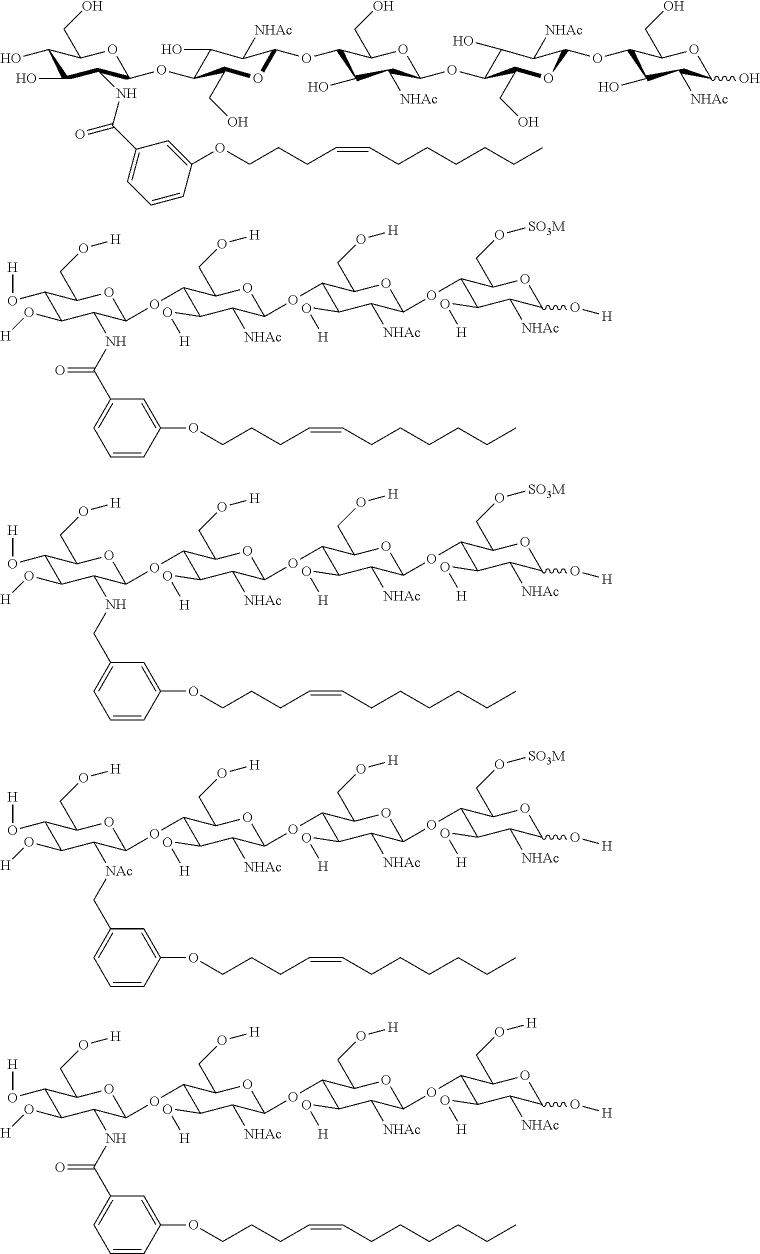 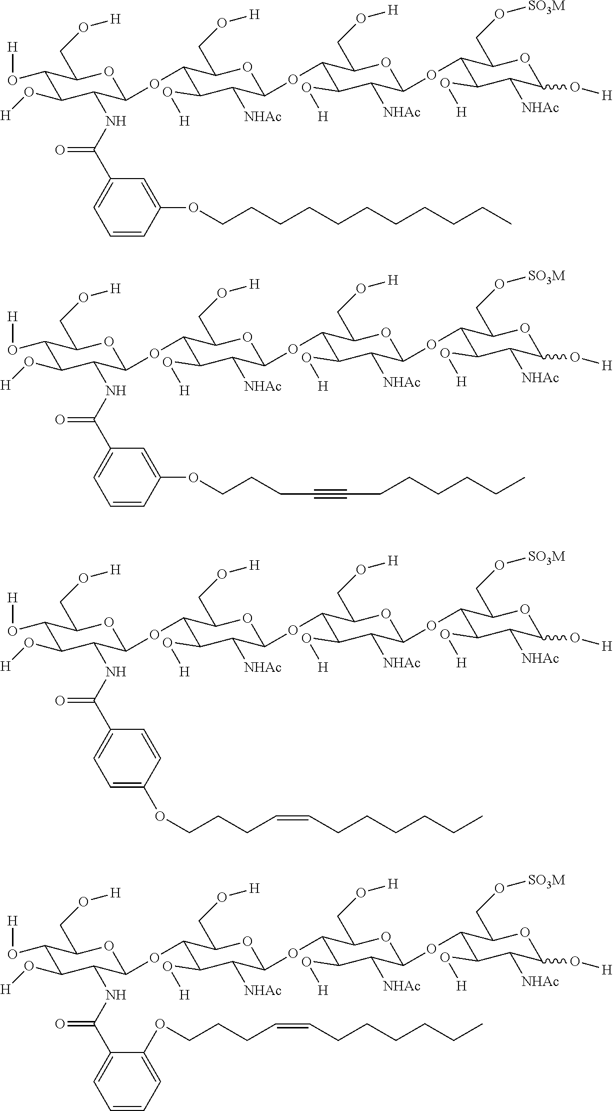 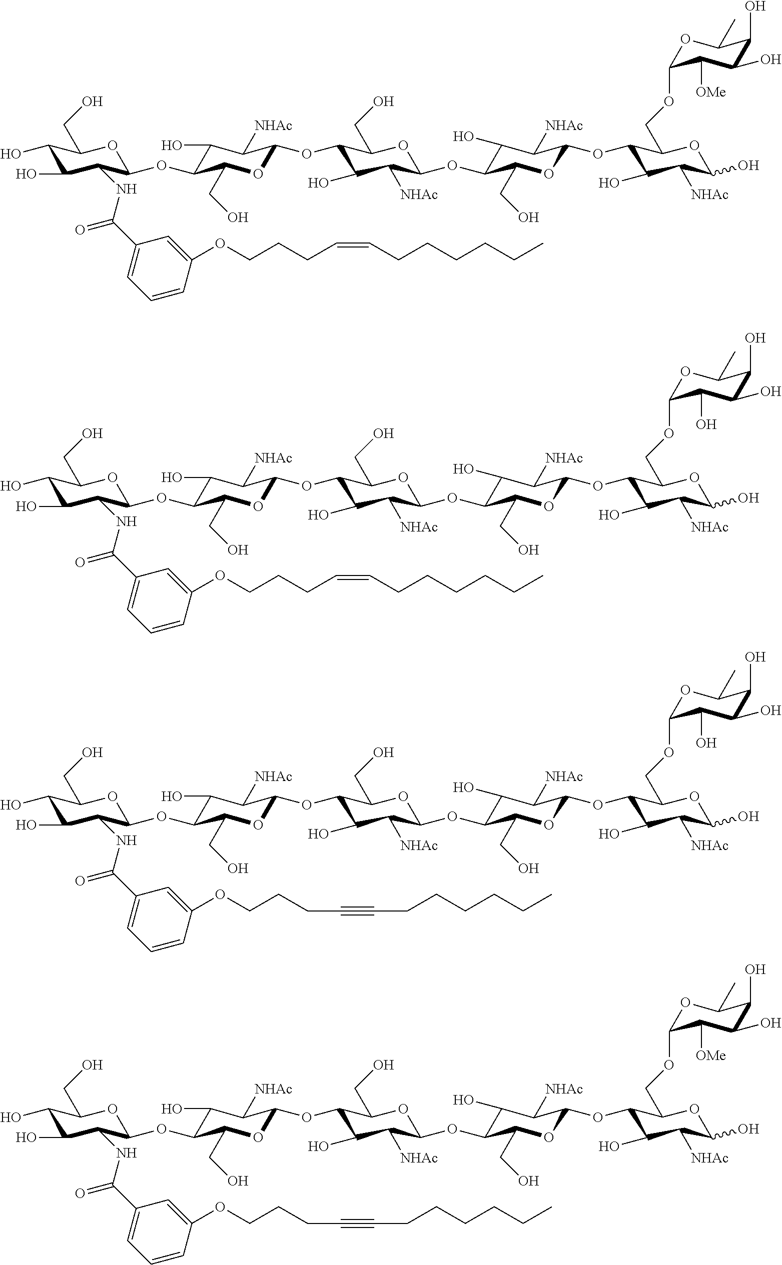 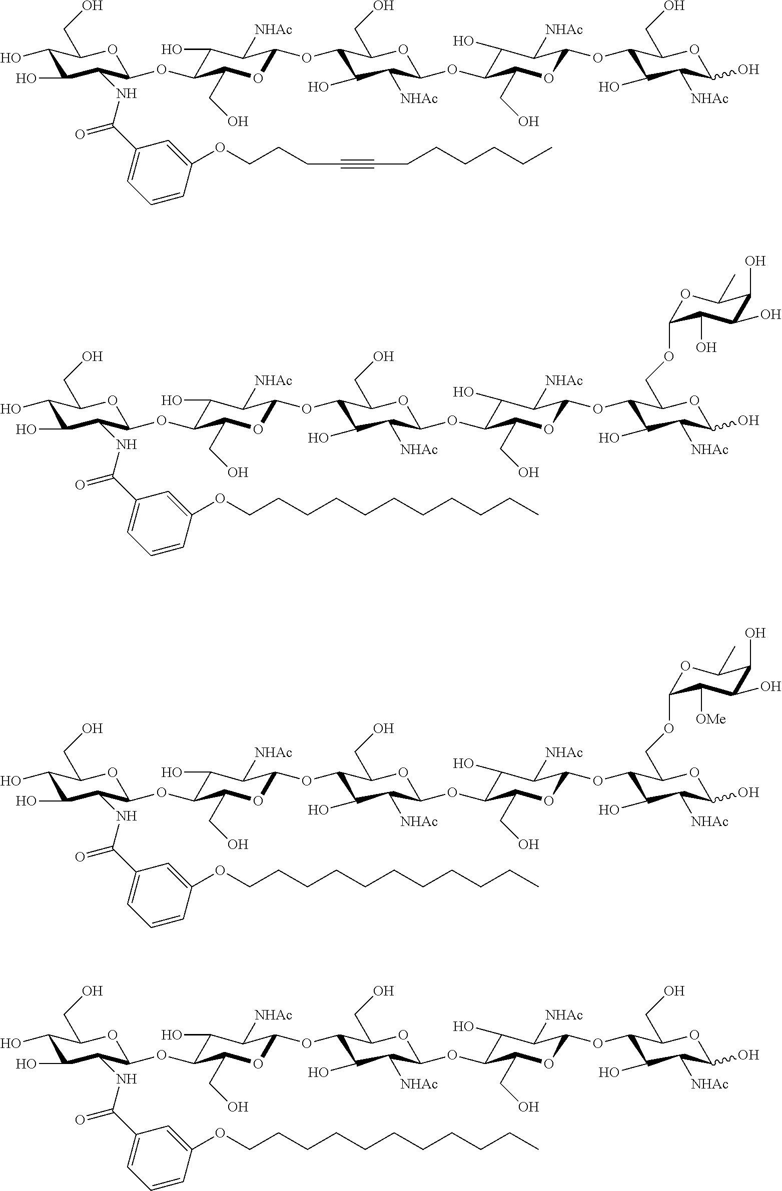
in which, when it is present, M represents a cation chosen from H⁺, Li⁺, Na⁺, K⁺ and (C₁₋₈alkyl)₄N⁺.

7. The method according to claim 1 wherein said lipochito-oligosaccharide (component (a)) is associated with said fungicide (component (b)) in a (a)/(b) weight ratio of from 1/1 to 1/10¹⁴.

8. The method according to claim 1 wherein said lipochito-oligosaccharide (component (a)) is associated with said insecticide, acaricide or nematicide (component (c)) in a (a)/(c) weight ratio of from 1/1 to 1/10¹³.

9. The method according to claim 1, characterized in that the seed of the plant is in a first step hydrated, and in a second step dried, before being treated in a third step with the said seed treatment containing at least one fungicidal, insecticidal, acaricidal or nematicidal compound associated with said lipochito-oligosaccharide.

10. The method according to claim 1, wherein the seedlings are selected from the following genera:
Agricultural crops: Arachis, Avena, Beta, Brassica, Carthamus, Glycine, Gossypium, Helianthus, Hordeum, Lolium, Medicago, Oryza, Poa, Secale, Sorghum, Trifolium, Triticum, Triticale and Zea;
Vegetable crops: Allium, Apium, Asparagus, Brassica, Capsicum, Cicer, Cichorium, Citrillus, Cucumis, Cucurbita, Cynara, Daucus, Lactuca, Lens, Phaseolus, Pisum, Raphanus, Solanum (including tomato, also frequently indicated as Lycopersicon esculentum), Spinacia, Valerianella and Vicia;
Flower crops: Antirrhinum, Begonia, Chrysanthemum, Cyclamen, Dianthus, Gazania, Gerbera, Impatiens, Ipomoea, Lavatera, Lobelia, Pelargonium, Petunia, Phlox, Primula, Salvia, Tageta, Verbena, Vinca, Viola and Zinnia.

11. The method according to claim 1 wherein the fungicidal compound is selected from penflufen, benalaxyl, ethirimol, hymexazol, mefenoxam, metalaxyl, metalaxyl-M, benomyl, carbendazim, fuberidazole, pencycuron, thiabendazole, zoxamide, boscalid, carboxin, flutolanil, furametpyr, penthiopyrad, thifluzamide, azoxystrobin, cyazofamid, dimoxystrobin, famoxadone, fenamidone, fluoxastrobin, metominostrobin, orysastrobin, picoxystrobin, pyraclostrobin, trifloxystrobin, fluazinam, silthiofam, cyprodinil, kasugamycin, mepanipyrim, pyrimethanil, fenpiclonil, fludioxonil, iprodione, procymidone, propamocarb, tolclofos-methyl, bitertanol, cyproconazole, difenoconazole, diniconazole, epoxiconazole, etaconazole, fenhexamid, fluquinconazole, flutriafol, hexaconazole, imazalil, imibenconazole, ipconazole, metconazole, prochloraz, prothioconazole, simeconazole, spiroxamine, tebuconazole, tetraconazole, triadimefon, triadimenol, triflumizole, triticonazole, carpropamid, tolylfluanid, fluopicolide, isotianil, N-{2-[1,1′-bi(cyclopropyl)-2-yl]phenyl}-3-(difluoromethyl)-, 1-methyl-1H-pyrazole-4-carboxamide, propamocarb fosetylate, triazoxide, N-(3′,4′-dichloro-5-fluorobiphenyl-2-yl)-3-(difluoromethyl)-1-methyl-1H-pyrazole-4-carboxamide, N-{2-[3-chloro-5-(trifluoromethyl)pyridin-2-yl]ethyl}-2-(trifluoromethyl)benzamide.

12. The method according to claim 1, wherein the insecticidal, acaricidal or nematicidal compound is selected from the list consisting of:
(1.1.1) clothianidin, (1.1.2) imidacloprid, (1.1.3) thiacloprid, (1.1.4) thiamethoxam, (1.1.5) acetamiprid, (2.1.1) methiocarb, (2.1.2) thiodicarb, (2.1.3) aldicarb,
(2.2.1)ethoprophos, (2.2.2) fenamiphos, (3.1.1) beta-cyfluthrin, (3.1.2) cyfluthrin, (3.1.3) deltamethrin, (3.1.4) tefluthrin, (3.2.1) indoxacarb, (4.1.1) spinosad, (4.1.2)spinetoram,
(5.2.1) fipronil, (5.2.2) ethiprole, (6.1.1) emamectin-benzoate, (6.1.2)avermectin, (7.1.1) pyriproxifen, (8.1.1) methoxyfenozide, (9.1.1) triflumuron,
(9.1.2) flufenoxuron, (10.1) diafenthiuron, (10.2) organotins, (11.1) pyrrole, (11.2) dinitrophenole, (12.1.1)tebufenpyrad, (12.2.1) hydramethylnone, (13.1) rotenone, (14.1) acequinocyl, fluacrypyrim, (15.1) Bacillus thuringiensis-strains, (16.1.1) spirodiclofen,
(16.1.2) spiromesifen, (16.2.1) spirotetramat, (17.1) flonicamid, (18.1)amitraz, (19.1) propargite,
(20.1) N²-[1,1-dimethyl-2-(methylsulfonyl)ethyl]-3-iodo-N¹-[2-methyl-4-[1,2,2,2-tetrafluor-1-(trifluormethyl)ethyl]phenyl]-1,2-benzenedicarboxamide (flubendiamide, CAS-Reg.-No.: 272451-65-7), (20.2) rynaxypyr, (20.3) cyazypyr of the formula,
(21.1) thiocyclam hydrogen oxalate, thiosultap-sodium, (22.1) azadirachtin, Bacillus spec., Beauveria spec., codlemone, Metarrhizium spec., Paecilomyces spec., thuringiensin, Verticillium spec., (23.1) fumigants (e.g. aluminium phosphide, methyl bromide, sulfuryl fluoride); (23.2) elective inhibitors of insect feeding (e.g. cryolite, flonicamid, pymetrozine); (23.3) inhibitors of mite growth (e.g. clofentezine, etoxazole, hexythiazox); (23.4) amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flu-tenzin, gossyplure, hydramethylnone, japonilure, metoxadiazone, petroleum, piperonyl butoxide, potassium oleate, pyrafluprole, pyridalyl, pyriprole, sulfluramid, tetradifon, tetrasul, triarathene, verbutin, 3-methyl-phenyl-propylcarbamat (tsumacide z), 3-(5-chlor-3-pyridinyl)-7-(2,2,2-trifluorethyl)-7-azabicyclo[3.2.1]octan-3-carbonitril (cas-reg.-nr. 175972-70-3) and the corresponding 3-endo-isomer (cas-reg.-nr. 175974-60-5).

13. The method according to claim 9, wherein the seed is hydrated by hydropriming (including drumpriming), osmopriming, or solid matrix priming, and dried to a moisture content of 3 to 15% on a fresh weight basis.

14. The method according to claim 9, wherein the seed is hydrated by hydropriming for 1 to 24 hours, at temperatures from 10° C. to 3° C., or drumprimed for 5 to 17 days, at temperatures from 10° C. to 30° C., or osmoprimed for 3 to 15 days, at temperatures from 10° C. to 30° C., with an osmotic potential of −0.5 to −2.6 MPa, or solid matrix primed for 3 to 15 days, at temperatures from 10° C. to 30° C., with an osmotic potential of −0.5 to −2.6 MPa.
